(19) United States
(12) Patent Application Publication
(10) Pub. No.: US 2025/0303708 A1
(43) Pub. Date: Oct. 2, 2025

(54) Liquid Ejecting Apparatus And Method For Driving Liquid Ejecting Apparatus

(71) Applicant: SEIKO EPSON CORPORATION, Tokyo (JP)

(72) Inventors: Hanqing YOU, Shiojiri (JP); Masahiro ASAMI, Shiojiri (JP); Toyohiko MITSUZAWA, Shiojiri (JP); Yuki HANAMURA, Azumino (JP); Shushi MAKITA, Shiojiri (JP)

(21) Appl. No.: 19/089,373

(22) Filed: Mar. 25, 2025

(30) Foreign Application Priority Data
Mar. 26, 2024 (JP) 2024-050452

(51) Int. Cl. B41J 2/045

(52) U.S. Cl. CPC B41J 2/04588; B41J 2/04541; B41J 2/04573; B41J 2/04581

(57) ABSTRACT

A liquid ejecting apparatus includes a discharge portion having a drive element that is drove with a drive signal. The drive signal includes a plurality of discharge pulses corresponding to a plurality of droplets that combine before landing on a medium. A first discharge pulse of the plurality of discharge pulses includes a first contraction element that changes a potential from a first potential to a second potential to contract a volume of a pressure chamber, a first contraction maintaining element, and a first re-contraction element that changes a potential from the second potential to a third potential to further contract the volume of the pressure chamber. A first potential difference from the first potential to the second potential of the first discharge pulse is equal to or greater than 20% and less than 50% of a second potential difference from the first potential to the third potential.

The present application is based on, and claims priority from JP Application Serial Number 2024-050452, filed Mar. 26, 2024, the disclosure of which is hereby incorporated by reference herein in its entirety.

### BACKGROUND

### 1. Technical Field

The present disclosure relates to a liquid ejecting apparatus having a discharge portion that ejects liquid from a nozzle and a method for driving a liquid ejecting apparatus, and more particularly to an ink jet recording apparatus that ejects ink as liquid and a method for driving an ink jet recording apparatus.

### 2. Related Art

A liquid ejecting apparatus, which is represented by an ink jet recording apparatus such as an ink jet printer or a plotter, includes a discharge portion capable of ejecting liquid, such as ink, stored in a cartridge, a tank, or the like, as droplets.

A discharge portion includes a nozzle that ejects liquid, a pressure chamber that communicates with the nozzle, and a drive element that causes pressure fluctuations in the liquid in the pressure chamber. By supplying a drive signal including a plurality of discharge pulses within one unit period to the drive element, there is a liquid ejecting apparatus that ejects a plurality of droplets from the nozzle and causes the plurality of droplets to combine during flight and land on a medium (see, for example, JP-A-2017-140761).

However, when an interval between discharge pulses is narrowed in order to discharge droplets at high frequency, there is a problem in that the discharge of droplets becomes unstable. In particular, when a low-viscosity liquid is used, the residual vibration of the liquid in the pressure chamber after droplets are discharged by the discharge pulse is more intense than when a high-viscosity liquid is used; therefore, in order to suppress the residual vibration, it is necessary to increase the interval between the discharge pulses or to reduce the rate of potential change over time when the volume of the pressure chamber is contracted, making high-frequency discharge difficult.

### SUMMARY

According to an aspect of the present disclosure, there is provided a liquid ejecting apparatus including: a discharge portion having a nozzle that ejects liquid, a pressure chamber that communicates with the nozzle, and a drive element that causes a pressure fluctuation in the liquid in the pressure chamber when a drive signal is supplied to the drive element; and a drive signal generation section that generates the drive signal, in which the drive signal includes a plurality of discharge pulses corresponding to a plurality of droplets that combine before landing on a medium, a first discharge pulse in time series among the plurality of discharge pulses includes a first contraction element that changes a potential from a first potential to a second potential to contract a volume of the pressure chamber, a first contraction maintaining element that maintains the second potential following the first contraction element, and a first re-contraction element that changes a potential from the second potential to a third potential following the first contraction maintaining element to further contract the volume of the pressure chamber, a last discharge pulse in time series among the plurality of discharge pulses includes a last contraction element that changes a potential from a fourth potential to a fifth potential to contract the volume of the pressure chamber, and a first potential difference from the first potential to the second potential of the first discharge pulse is equal to or greater than 20% and less than 50% of a second potential difference from the first potential to the third potential.

According to another aspect of the present disclosure, there is provided a method for driving a liquid ejecting apparatus including a discharge portion having a drive element that causes a pressure fluctuation in liquid in a pressure chamber that communicates with a nozzle that ejects the liquid when a drive signal is supplied to the drive element, in which the drive signal includes a plurality of discharge pulses corresponding to a plurality of droplets that combine before landing on a medium, a first discharge pulse in time series among the plurality of discharge pulses includes a first contraction element that changes a potential from a first potential to a second potential to contract a volume of the pressure chamber, a first contraction maintaining element that maintains the second potential following the first contraction element, and a first re-contraction element that changes a potential from the second potential to a third potential following the first contraction maintaining element to further contract the volume of the pressure chamber, a last discharge pulse in time series among the plurality of discharge pulses includes a last contraction element that changes a potential from a fourth potential to a fifth potential to contract the volume of the pressure chamber, and a first potential difference from the first potential to the second potential of the first discharge pulse is equal to or greater than 20% and less than 50% of a second potential difference from the first potential to the third potential.

### BRIEF DESCRIPTION OF THE DRAWINGS

FIG. 1 is a diagram showing a schematic configuration of a liquid ejecting apparatus according to a first embodiment.

FIG. 2 is a cross-sectional view of a discharge portion according to the first embodiment.

FIG. 3 is a block diagram showing an electrical configuration of the liquid ejecting apparatus according to the first embodiment.

FIG. 4 shows a drive waveform of a drive signal according to the first embodiment.

FIG. 5 is a table showing a potential and a period of each element of the drive signal according to the first embodiment.

FIG. 6 shows a drive waveform of a drive signal according to a second embodiment.

FIG. 7 is a table showing a potential and a period of each element of the drive signal according to the second embodiment.

FIG. 8 shows a drive waveform of a drive signal according to a third embodiment.

FIG. 9 is a table showing a potential and a period of each element of the drive signal according to the third embodiment.

FIG. 10 shows a drive waveform of a drive signal according to a fourth embodiment.

FIG. 11 is a table showing a potential and a period of each element of the drive signal according to the fourth embodiment.

FIG. 12 shows a drive waveform of a drive signal according to a fifth embodiment.

FIG. 13 is a table showing a potential and a period of each element of the drive signal according to the fifth embodiment.

FIG. 14 shows a drive waveform of a drive signal according to a sixth embodiment.

FIG. 15 is a table showing a potential and a period of each element of the drive signal according to the sixth embodiment.

### DESCRIPTION OF EMBODIMENTS

The present disclosure will be described in detail below based on embodiments. However, the following description shows one embodiment of the present disclosure, and can be modified as desired within the scope of the present disclosure. In each drawing, the same reference numerals indicate the same members, and the description thereof will be omitted as appropriate. In each drawing, X, Y, and Z represent three spatial axes that are orthogonal to each other. In the present specification, the directions along these axes are referred to as an X direction, a Y direction, and a Z direction. In each drawing, a direction indicated by the arrow is a positive (+) direction, and a direction opposite to the arrow is a negative (−) direction. The Z direction indicates a vertical direction, the +Z direction indicates a vertically downward direction, and the −Z direction indicates a vertically upward direction. Furthermore, the directions of the three spatial axes, which are not limited to the positive direction and the negative direction, will be described as an X-axis direction, a Y-axis direction, and a Z-axis direction.

### First Embodiment

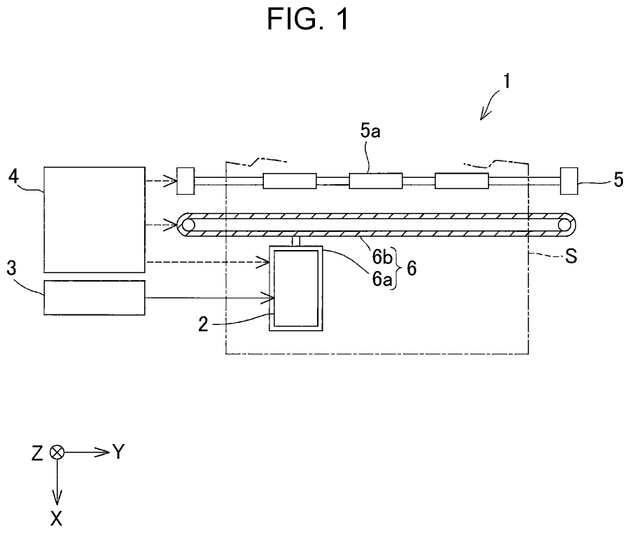

FIG. 1 is a diagram showing a schematic configuration of a liquid ejecting apparatus 1 according to the present disclosure.

As shown in the drawing, the liquid ejecting apparatus 1 is a so-called serial printer that includes a discharge portion 2 and performs printing by transporting a medium S in the X-axis direction while reciprocating the discharge portion 2 in the Y-axis direction, and discharging (also called ejecting) liquid from the discharge portion 2 toward the medium S in the +Z direction. As the medium S, in addition to recording paper, any material such as a resin film or cloth can be used.

The liquid ejecting apparatus 1 includes a discharge portion 2, a liquid storage portion 3, a control portion 4, a transport mechanism 5 that sends out the medium S, and a moving mechanism 6.

The discharge portion 2 ejects the liquid supplied from the liquid storage portion 3 in the form of droplets in the +Z direction.

The liquid storage portion 3 stores the liquid to be ejected from the discharge portion 2. Examples of the liquid storage portion 3 include a cartridge that is attachable and detachable to the liquid ejecting apparatus 1, a bag-shaped ink pack made of a flexible film, and an ink tank that can be replenished with ink. Although not particularly shown, the liquid storage portion 3 stores, for example, a plurality of types of ink having different colors, components, and the like, individually. Furthermore, the liquid storage portion 3 may be divided into a main tank and a sub-tank. A sub-tank may be coupled to the discharge portion 2, and the liquid consumed by ejecting droplets from the discharge portion 2 may be replenished from the main tank to the sub-tank. Furthermore, the liquid may be circulated between the liquid storage portion 3 and the discharge portion 2.

The control portion 4 includes, for example, a control device such as a central processing unit (CPU) or a field programmable gate array (FPGA), and a storage device such as a semiconductor memory. The control portion 4 also includes a power supply device that supplies power supplied from an external power source such as a commercial power source to each element of the liquid ejecting apparatus 1. The control portion 4 is electrically coupled to the discharge portion 2 via an external wiring (not shown). The control portion 4 comprehensively controls each element of the liquid ejecting apparatus 1 by the control device executing a program stored in the storage device.

The transport mechanism 5 transports the medium S in the X-axis direction, and has, for example, a transport roller 5a that is rotated by a transport motor that is driven under the control of the control portion 4.

The moving mechanism 6 is a mechanism for reciprocating the discharge portion 2 in the Y-axis direction, and includes a holder 6a that holds the discharge portion 2 and a transport belt 6b that is an endless belt erected along the Y-axis direction. The control portion 4 rotates the transport belt 6b by controlling the drive of a transport motor (not shown) to reciprocate the discharge portion 2 in the Y-axis direction together with the holder 6a fixed to the transport belt 6b.

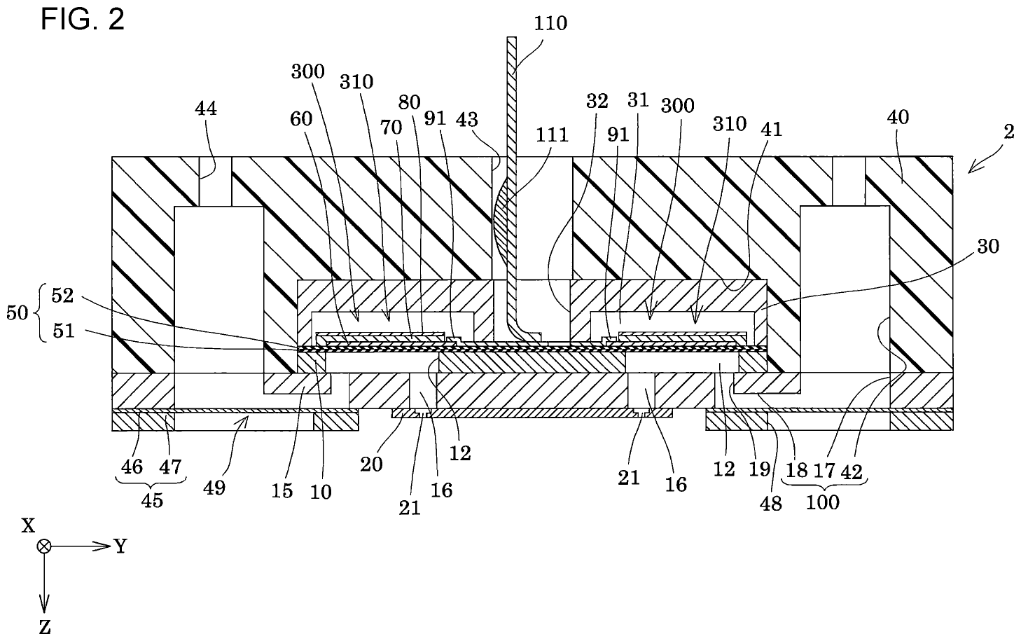

Under the control of the control portion 4, the discharge portion 2 executes an ejection operation of ejecting ink supplied from the liquid storage portion 3 as droplets from each of a plurality of nozzles 21 (see FIG. 2) in the +Z direction. The ejection operation by the discharge portion 2 is performed in parallel with the transporting of the medium S by the transport mechanism 5 and the reciprocating movement of the discharge portion 2 by the moving mechanism 6, so that so-called printing in which the ink is applied to the medium S is performed.

FIG. 2 is a cross-sectional view of the discharge portion 2 according to one embodiment of the present disclosure. Each direction of the discharge portion 2 will be described based on the directions when the discharge portion 2 is mounted on the liquid ejecting apparatus 1, that is, the X-axis direction, the Y-axis direction, and the Z-axis direction.

As shown in the drawings, the discharge portion 2 of the present embodiment includes a pressure chamber substrate 10, a communication plate 15, a nozzle plate 20 having a plurality of nozzles 21 formed therein, a protective substrate 30, a case member 40, a piezoelectric actuator 300, and a wiring member 110.

The pressure chamber substrate 10 is made of, for example, a silicon substrate. In the pressure chamber substrate 10, a plurality of pressure chambers 12 are arranged side by side along the X-axis direction. The plurality of pressure chambers 12 are arranged side by side along the X-axis direction to be at the same position in the Y-axis direction. Two pressure chambers 12 adjacent to each other in the X-axis direction are partitioned by a partition wall (not shown). In the present embodiment, two pressure chamber rows, in which the pressure chambers 12 are arranged side by side along the X-axis direction, are provided in the Y-axis direction.

The communication plate 15 and the nozzle plate 20 are sequentially stacked on the surface of the pressure chamber substrate 10 facing the +Z direction. A vibration plate 50 and a piezoelectric actuator 300 are sequentially stacked on the surface of the pressure chamber substrate 10 facing the −Z direction.

The communication plate 15 is made of a plate-shaped member bonded to a surface of the pressure chamber substrate 10 facing the +Z direction. The communication plate 15 is provided with a nozzle communication passage 16 that makes the pressure chamber 12 and the nozzle 21 communicate with each other. The communication plate 15 is provided with a first common liquid chamber portion 17 and a second common liquid chamber portion 18 that constitute a common liquid chamber 100 through which the plurality of pressure chambers 12 communicate in common. The first common liquid chamber portion 17 is provided to penetrate the communication plate 15 in the Z-axis direction. Further, the second common liquid chamber portion 18 is provided to be open on the surface facing the +Z direction without penetrating the communication plate 15 in the Z-axis direction. Furthermore, the communication plate 15 is provided with a supply communication passage 19 that communicates with one end portion of the pressure chamber 12 in the Y-axis direction, independently for each pressure chamber 12. The supply communication passage 19 causes the second common liquid chamber portion 18 and the pressure chamber 12 to communicate with each other, and supplies the ink in the common liquid chamber 100 to the pressure chamber 12. As such a communication plate 15, a silicon substrate or the like can be used.

The nozzle plate 20 is bonded to the surface of the communication plate 15 facing the +Z direction. The nozzle plate 20 has nozzles 21 formed therein, which communicate with each of the pressure chambers 12 through the nozzle communication passage 16. In the present embodiment, the plurality of nozzles 21 are arranged side by side in a row along the X-axis direction. In the present embodiment, two nozzle rows, in which the nozzles 21 are arranged side by side along the X-axis direction, are provided spaced apart in the Y-axis direction.

The material of the nozzle plate 20 is not particularly limited, and for example, a silicon substrate or the like can be used.

The vibration plate 50 has, for example, an elastic film 51 made of silicon oxide provided on the pressure chamber substrate 10 side, and an insulator film 52 made of zirconium oxide provided on the surface of the elastic film facing the −Z direction.

The piezoelectric actuator 300 includes a first electrode 60 sequentially stacked on the vibration plate 50 in the −Z direction, a piezoelectric layer 70 constructed using a piezoelectric material made of a composite oxide having a perovskite structure represented by, for example, a general formula ABO₃, and a second electrode 80. Such a piezoelectric actuator 300 is also called a piezoelectric element, and refers to a portion including the first electrode 60, the piezoelectric layer 70, and the second electrode 80. In addition, a portion where piezoelectric strain occurs in the piezoelectric layer 70 when a voltage is applied between the first electrode 60 and the second electrode 80 is referred to as an active portion 310. Meanwhile, a portion where piezoelectric strain does not occur in the piezoelectric layer 70 is referred to as an inactive portion. That is, the active portion 310 refers to a portion where the piezoelectric layer 70 is interposed between the first electrode 60 and the second electrode 80. In the present embodiment, the active portion 310 is formed for each pressure chamber 12. In other words, a plurality of active portions 310 are formed in the piezoelectric actuator 300. The plurality of active portions 310 serve as drive elements that cause a pressure change in the ink in the pressure chamber 12. In general, one of the electrodes of the active portion 310 is configured as an independent individual electrode for each active portion 310, and the other electrode is configured as a common electrode common to the plurality of active portions 310. In the present embodiment, the first electrode 60 is configured as an individual electrode, and the second electrode 80 is configured as a common electrode.

From each electrode of the piezoelectric actuator 300, a lead electrode 91 serving as a lead wiring is drawn out. A wiring member 110 made of a flexible substrate having flexibility is coupled to the end portion of the lead electrode 91 opposite to the end portion coupled to the piezoelectric actuator 300. The wiring member 110 is mounted with a drive circuit 111 having a plurality of switching elements that select whether or not to supply a drive signal for driving each of the active portions 310 to each of the active portions 310. In other words, the wiring member 110 in the present embodiment is a chip-on-film (COF). The wiring member 110 may not be provided with the drive circuit 111. In other words, the wiring member 110 may be a flexible flat cable (FFC), a flexible printed circuit (FPC), and the like.

The protective substrate 30 having substantially the same size as the pressure chamber substrate 10 is bonded to the surface of the pressure chamber substrate 10 facing the −Z direction. The protective substrate 30 has an accommodation portion 31 which is a space for protecting the piezoelectric actuator 300. The accommodation portion 31 is independently provided for each row of the piezoelectric actuators 300 arranged side by side in the X-axis direction, and two accommodation portions 31 are formed side by side in the Y-axis direction. A through hole 32 penetrating in the Z-axis direction is provided between the two accommodation portions 31 arranged side by side in the Y-axis direction, in the protective substrate 30. The end portion of the lead electrode 91 drawn out from each electrode of the piezoelectric actuator 300 extends to be exposed within the through hole 32, and the lead electrode 91 and the wiring member 110 are electrically coupled within the through hole 32. Such a protective substrate 30 is made of, for example, a silicon substrate.

Also, the case member 40 that defines the common liquid chamber 100 that communicates with the plurality of pressure chambers 12 is fixed onto the protective substrate 30. The case member 40 has substantially the same shape as the communication plate 15 described above in a plan view, and is bonded to the protective substrate 30 and also bonded to the communication plate 15 described above.

The case member 40 has a recess 41 having a depth for accommodating the pressure chamber substrate 10 and the protective substrate 30 on the protective substrate 30 side. The recess 41 has an opening area wider than the surface of the protective substrate 30 bonded to the pressure chamber substrate 10. With the pressure chamber substrate 10 and the protective substrate 30 accommodated in the recess 41, the opening surface of the recess 41 on the nozzle plate 20 side is sealed by the communication plate 15.

The case member 40 is also provided with a third common liquid chamber portion 42 that communicates with the first common liquid chamber portion 17 of the communication plate 15. The first common liquid chamber portion 17 and the second common liquid chamber portion 18 provided in the communication plate 15 and the third common liquid chamber portion 42 provided in the case member 40 constitute the common liquid chamber 100 of the present embodiment. The common liquid chambers 100 are provided for each row of the pressure chambers 12, that is, two common liquid chambers in total. Each common liquid chamber 100 is provided continuously along the X-axis direction in which the pressure chambers 12 are arranged side by side, and the supply communication passages 19 that communicate each pressure chamber 12 with the common liquid chamber 100 are arranged side by side in the X-axis direction. Further, the case member 40 is provided with an introduction port 44 that communicates with the common liquid chamber 100 and supplies ink to each common liquid chamber 100. The case member 40 is also provided with a coupling port 43 that communicates with the through hole 32 of the protective substrate 30 and through which the wiring member 110 is inserted. As such a material of the case member 40, a metal material, a resin material, or the like is used.

In addition, a compliance substrate 45 is provided on the surface of the communication plate 15 on the +Z direction side where the first common liquid chamber portion and the second common liquid chamber portion 18 open. The compliance substrate 45 seals the openings of the first common liquid chamber portion 17 and the second common liquid chamber portion 18 on the ejection surface side. In the present embodiment, such a compliance substrate 45 includes a sealing film 46 made of a flexible thin film, and a fixed substrate 47 made of a hard material such as metal. The area of the fixed substrate 47 facing the common liquid chamber 100 is an opening portion 48 that is completely removed in the thickness direction, so that one side of the common liquid chamber 100 forms a compliance portion 49, which is a flexible portion sealed only by a flexible sealing film 46.

Such an discharge portion 2 takes in liquid from the liquid storage portion 3 through the introduction port into the common liquid chamber 100, filling the interior from the common liquid chamber 100 to the nozzle 21, and then applies a voltage to each active portion 310 corresponding to the pressure chamber 12 in accordance with a recording signal from the drive circuit 111. Accordingly, the vibration plate 50 together with the active portion 310 is deflected and deformed, the pressure of the liquid in each pressure chamber 12 increases, and droplets are ejected from each nozzle 21.

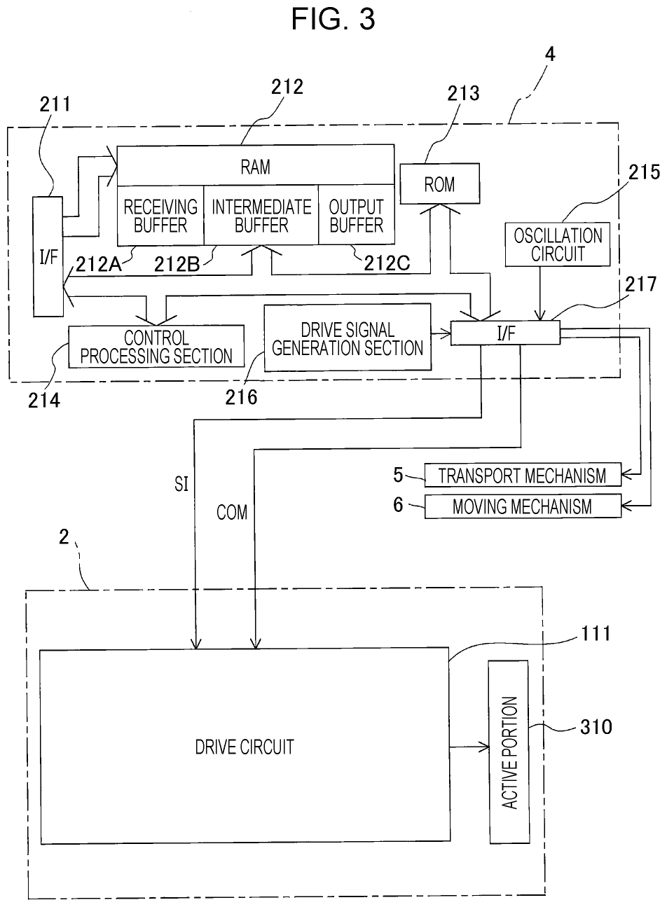

FIG. 3 is a block diagram showing an electrical configuration of the liquid ejecting apparatus 1. The control portion 4 is an element that controls the entire liquid ejecting apparatus 1. The control portion 4 includes an external interface 211 (hereinafter referred to as the external I/F 211), a RAM 212 for temporarily storing various types of data, a ROM 213 for storing a control program and the like, a control processing section 214 including a CPU and the like, an oscillation circuit 215 for generating a clock signal (CK), a drive signal generation section 216 for generating a drive signal to be supplied to the discharge portion 2, and an internal interface 217 (hereinafter referred to as the internal I/F 217).

The external I/F 211 is an interface for transmitting and receiving data to and from a host computer (not shown) or the like. The data received by the control portion 4 from the host computer via the external I/F 211 includes, for example, print data configured with character codes, graphic functions, image data, and the like. Moreover, examples of data transmitted by the control portion 4 via the external I/F 211 include a busy signal (BUSY) and an acknowledge signal (ACK). The RAM 212 functions as a receiving buffer 212A, an intermediate buffer 212B, an output buffer 212C, and a work memory (not shown). The receiving buffer 212A temporarily stores print data received by the external I/F 211, the intermediate buffer 212B stores intermediate code data converted by the control processing section 214, and the output buffer 212C stores dot pattern data. This dot pattern data is configured with recording data (SI) obtained by decoding (translating) the gradation data.

The drive signal generation section 216 generates a drive signal COM. As will be described in more detail later, the drive signal COM is a signal that has a first discharge pulse DP1 and a second discharge pulse DP2 within one unit period T, which drive the active portion 310 to discharge a plurality of droplets from the nozzle 21, and is repeatedly generated for each unit period T. A plurality of droplets discharged by driving the active portion 310 with the first discharge pulse DP1 and the second discharge pulse DP2 land on the medium S before landing on the medium S, that is, after combining during flight. The unit period T is also called a drive period T, which is a repeating unit of the drive signal COM and corresponds to one pixel of an image to be printed on the medium S.

The ROM 213 stores font data, graphic functions, and the like in addition to a control program (control routine) for causing the control processing section 214 to perform various types of data processing. The control processing section 214 reads the print data in the receiving buffer 212A and stores intermediate code data obtained by converting the print data in the intermediate buffer 212B. Moreover, the intermediate code data read from the intermediate buffer 212B is analyzed, and the intermediate code data is expanded into recording data by referring to the font data and graphic functions stored in the ROM 213. Then, the control processing section 214 performs necessary decoration processing and then stores the expanded recording data in the output buffer 212C. The control program may be read from a recording medium such as a floppy disk, a CD-ROM, a DVD-ROM, or a USB memory that is directly coupled via the external I/F 211 or that is coupled via a host computer. The control program may also be provided in the host computer as a printer driver.

During printing, when the control processing section 214 obtains recording data equivalent to one line of the discharge portion 2, the control processing section 214 outputs this one line of recording data to the discharge portion 2 through the internal I/F 217. Furthermore, when one line of recording data is output from the output buffer 212C, the expanded intermediate code data is erased from the intermediate buffer 212B, and the expansion processing is performed on the next intermediate code data.

The discharge portion 2 includes a drive circuit 111. The drive circuit 111 is a circuit that supplies a drive signal COM to the active portion 310 based on the recording data (SI) sent from the control portion 4 via the internal I/F 217.

The recording data is configured with a plurality of pieces of pixel data to be discharged for each of a plurality of dots that constitute one line. For example, it is assumed that pixel data is binary, with “1” representing that a dot is to be formed and “0” representing that a dot is not to be formed. When the pixel data is “1”, the drive circuit 111 supplies the first discharge pulse DP1 to the active portion 310 which discharges droplets from the nozzle corresponding to the pixel data, and when the pixel data is “0”, the drive circuit 111 does not supply the first discharge pulse DP1 to the active portion 310.

In this manner, under the control of the control portion 4, the discharge portion 2 discharges droplets from each nozzle 21 at a timing defined by the recording data or the like. The control portion 4 controls the transport mechanism 5 to transport the medium S and the moving mechanism 6 to reciprocate the discharge portion 2 via the internal I/F 217 in parallel with the discharge operation by the discharge portion 2. Printing is performed on the medium S under such control of the control portion 4.

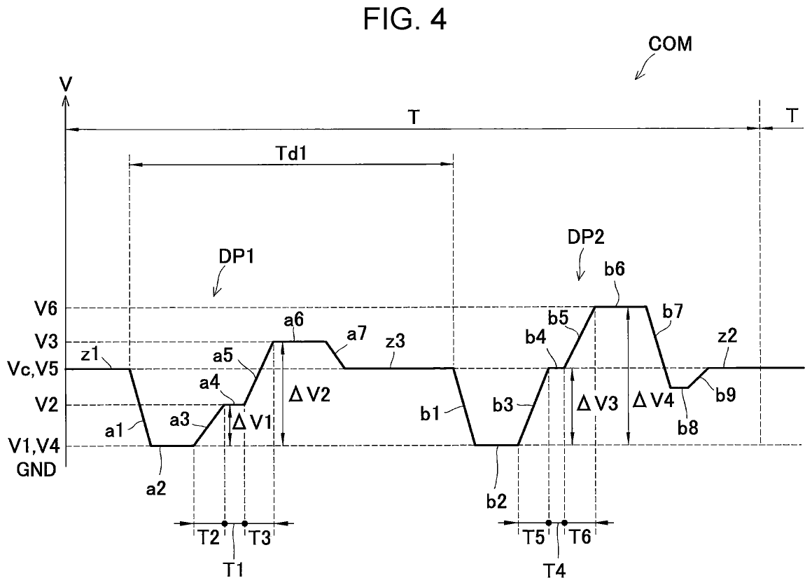

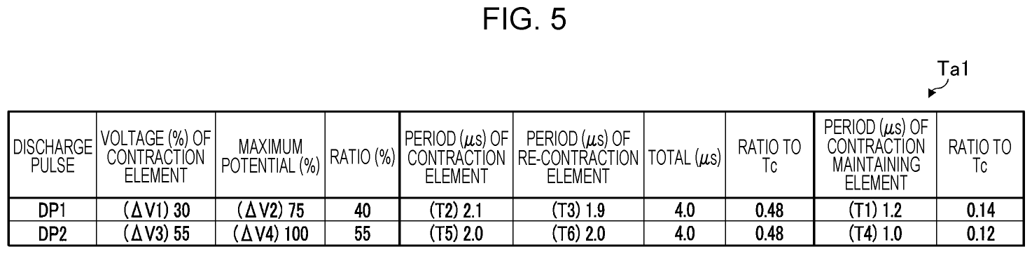

FIG. 4 is a drive waveform showing the drive signal COM. The potential and period of each element of the drive signal COM are shown in Table Ta1 of FIG. 5.

As shown in FIG. 4, the drive signal COM is repeatedly generated from the drive signal generation section 216 for each unit period T defined by a clock signal transmitted from the oscillation circuit 215. The unit period T corresponds to one pixel of an image or the like to be printed on the medium S. In the present embodiment, in a unit period T, a first discharge pulse DP1 and a second discharge pulse DP2 are generated. The droplets discharged from the nozzle 21 by driving the active portion 310 with the first discharge pulse DP1 and the droplets discharged from the nozzle 21 by driving the active portion 310 with the second discharge pulse DP2 are combined together before landing on the medium S, that is, before landing on the medium S during flight.

In the present embodiment, the drive signal COM is supplied to the first electrode 60 that is an individual electrode by using the second electrode 80 that is a common electrode for the active portion 310 as a reference potential. That is, the voltage applied to the second electrode 80 by the drive signal COM is represented as a potential with the reference potential as a reference.

The first discharge pulse DP1 of the drive signal COM has a first filling element a1, a first filling maintaining element a2, a first contraction element a3, a first contraction maintaining element a4, a first re-contraction element a5, a first re-contraction maintaining element a6, and a first expansion element a7, which are continuous in this order in time series.

The first filling element a1 changes the potential from a reference potential Vc to a first potential V1, thereby expanding the volume of the pressure chamber 12 from the reference volume corresponding to the reference potential Vc. By this first filling element a1, the liquid surface of the liquid in the nozzle 21 is drawn toward the pressure chamber 12 side, and liquid is supplied to the pressure chamber 12 from the common liquid chamber 100 side.

The first filling maintaining element a2 maintains the first potential V1 for a certain period of time. While the first filling maintaining element a2 is being supplied, pressure vibrations are generated in the liquid within the pressure chamber 12. The period of the pressure vibration of the liquid in the pressure chamber 12, that is, a natural vibration period Tc, can generally be expressed by the following equation.

$$T c = 2 {π [ ( Mn + Ms ) \times ( Cc + Ci ) / ( Mn \times Ms ) ]}^{1 / 2}$$

In the above equation, Mn is the inertance of the nozzle 21 (mass of the ink per unit cross-sectional area), Ms is the inertance of the supply communication passage 19, Cc is the compliance of the pressure chamber 12 (volume change per unit pressure, and indicates the degree of softness), and Ci is the compliance of the liquid (Ci=volume V/[density ρ× sound speed cb]). The natural vibration period Tc is, for example, 8 μs or more and 10 μs or less. In the present embodiment, the natural vibration period Tc is, for example, 8.4 μs.

In the first discharge pulse DP1, the drive for contracting the pressure chamber 12 is performed in two stages, the first contraction element a3 and the first re-contraction element a5.

The first contraction element a3 changes the potential from the first potential V1 to a second potential V2, thereby contracting the volume of the pressure chamber 12. The first contraction element a3 causes a liquid column to begin to protrude from the liquid surface of liquid inside the nozzle 21. The potential difference from the first potential V1 to the second potential V2 in the first stage contraction drive of the pressure chamber 12 is a first potential difference ΔV1.

The first contraction maintaining element a4 maintains the second potential V2 for a certain period of time. While the first contraction maintaining element a4 is being supplied to the active portion 310, the liquid column continues to extend.

The first re-contraction element a5 changes the potential from the second potential V2 to a third potential V3, thereby further contracting the volume of the pressure chamber 12. The first re-contraction element a5 causes the liquid column to extend, be torn off, and discharge as droplets. The potential difference from the first potential V1 to the third potential V3 during the two-stage contraction drive of the pressure chamber is a second potential difference ΔV2. The second potential difference ΔV2 may also be referred to as the maximum potential difference within the pulse in the first discharge pulse DP1.

The first re-contraction maintaining element a6 maintains the third potential V3 for a certain period of time. While the first re-contraction maintaining element a6 is being supplied to the active portion 310, pressure vibration occurs in the liquid within the pressure chamber with the natural vibration period Tc.

The first expansion element a7 changes the potential from the third potential V3 to the reference potential Vc, and expands the volume of the pressure chamber at the timing when the pressure vibration remaining in the ink in the pressure chamber 12 after the first re-contraction element a5 is positive pressure. The pressure vibration of the liquid in the pressure chamber 12 is weakened by this first expansion element a7.

In other words, the first re-contraction maintaining element a6 and the first expansion element a7 have a so-called vibration damping function that weakens the vibration of the liquid surface in the nozzle 21 after the droplets are discharged.

The second discharge pulse DP2 is generated after the first discharge pulse DP1 within one unit period T of the drive signal COM. The second discharge pulse DP2 has a second filling element b1, a second filling maintaining element b2, a second contraction element b3, a second contraction maintaining element b4, a second re-contraction element b5, a second re-contraction maintaining element b6, a second expansion element b7, a second expansion maintaining element b8, and a second return element b9, which are continuous in this order in time series.

The second filling element b1 changes the potential from the reference potential Vc to a fourth potential V4, thereby expanding the volume of the pressure chamber 12 from the reference volume. By this second filling element b1, the liquid surface of the liquid in the nozzle 21 is drawn toward the pressure chamber 12 side, and liquid is supplied to the pressure chamber 12 from the common liquid chamber side.

The second filling maintaining element b2 maintains the fourth potential V4 for a certain period of time. While the second filling maintaining element b2 is being supplied, pressure vibration occurs in the liquid within the pressure chamber 12 with the natural vibration period Tc.

Also in the second discharge pulse DP2, the drive for contracting the pressure chamber 12 is performed in two stages, a second contraction element b3 and a second re-contraction element b5.

The second contraction element b3 changes the potential from the fourth potential V4 to a fifth potential V5, thereby contracting the volume of the pressure chamber 12. The second contraction element b3 causes a liquid column to begin to protrude from the liquid surface of liquid inside the nozzle 21. The potential difference from the fourth potential V4 to the fifth potential V5 in the first stage contraction drive of the pressure chamber 12 is a third potential difference ΔV3.

The second contraction maintaining element b4 maintains the fifth potential V5 for a certain period of time. While the second contraction maintaining element b4 is being supplied to the active portion 310, the liquid column continues to extend.

The second re-contraction element b5 changes the potential from the fifth potential V5 to a sixth potential V6, thereby further contracting the volume of the pressure chamber 12. The second re-contraction element b5 causes the liquid column to extend and is then torn off and discharged as droplets. The potential difference from the fourth potential V4 to the sixth potential V6 during the two-stage contraction drive of the pressure chamber is a fourth potential difference ΔV4. The fourth potential difference ΔV4 may also be referred to as the maximum potential difference within the pulse in the second discharge pulse DP2. The fourth potential difference ΔV4 may also be referred to as the maximum potential difference within the drive signal in the drive signal COM.

The second re-contraction maintaining element b6 maintains the sixth potential V6 for a certain period of time. While the second re-contraction maintaining element b6 is being supplied to the active portion 310, pressure vibration occurs in the liquid within the pressure chamber with the natural vibration period Tc.

The second expansion element b7 changes the potential from the sixth potential V6 to a potential lower than the reference potential Vc at the timing when the pressure vibration remaining in the ink in the pressure chamber 12 after the second re-contraction element b5 is positive pressure, thereby expanding the volume of the pressure chamber 12. The pressure vibration of the liquid in the pressure chamber 12 is weakened by this second expansion element b7.

The second expansion maintaining element b8 maintains the termination potential of the second expansion element b7 for a certain period of time.

The second return element b9 changes the potential to the reference potential Vc at the timing when the pressure vibration remaining in the ink in the pressure chamber 12 after the second expansion element b7 is negative pressure, thereby contracting the volume of the pressure chamber 12. The pressure vibration of the liquid in the pressure chamber 12 is weakened by this second return element b9.

In other words, the second re-contraction maintaining element b6, the second expansion element b7, the second expansion maintaining element b8, and the second return element b9 have a so-called vibration damping function that weakens the vibration of the liquid surface in the nozzle 21 after the droplets are discharged.

Next, the point of contracting the volume of the pressure chamber 12 in two stages will be described in detail.

The first discharge pulse DP1 divides the drive for contracting the pressure chamber 12 by the first contraction maintaining element a4, thereby contracting the volume of the pressure chamber 12 in two stages, the first contraction element a3 and the first re-contraction element a5 to discharge droplets. By thus contracting the volume of the pressure chamber 12 in two stages to discharge droplets, it is possible to inhibit a reduction in the weight of the discharged droplets, and to suppress the residual vibration of the liquid surface in the nozzle 21 after the droplets are discharged relatively quickly compared to the case in which the volume of the pressure chamber 12 is contracted to discharge droplets by changing the potential in one stage from the first potential V1 to the third potential V3.

The first potential difference ΔV1 of the first contraction element a3 is equal to or greater than 20% and less than 50% of the second potential difference ΔV2 which is the maximum potential difference in the first discharge pulse DP1. In the present embodiment, as shown in table Ta1 of FIG. 5, the ratio of the first potential difference ΔV1 to the fourth potential difference ΔV4, which is the maximum potential difference of the drive signal COM, is 30%, and the ratio of the second potential difference ΔV2 is 75%. Therefore, the first potential difference ΔV1 is 40% of the second potential difference ΔV2.

Here, the flight speed of the droplets when the volume of the pressure chamber 12 is contracted in two stages to discharge the droplets changes depending on the ratio of the potential difference of the first stage of the pressure chamber 12 to the maximum potential difference in the pulse, which is the potential difference during the two-stage contraction drive of the pressure chamber 12. That is, the flight speed of the ink droplets discharged from the nozzle 21 changes depending on the ratio of the first potential difference ΔV1 to the second potential difference ΔV2. When the ratio of the first potential difference ΔV1 to the second potential difference ΔV2 is small, the flight speed of the ink droplets will be slow, and when the ratio of the first potential difference ΔV1 to the second potential difference ΔV2 is large, the flight speed of the ink droplets will be fast. Therefore, for example, when the first potential difference ΔV1 is less than 20% of the second potential difference ΔV2, the flight speed of the droplets discharged from the nozzle 21 becomes too slow, making the discharge of the droplets unstable. Furthermore, for example, when the first potential difference ΔV1 is equal to or greater than 50% of the second potential difference ΔV2, it is difficult to obtain the effect of suppressing residual vibration by discharging droplets in two stages, the first contraction element a3 and the first re-contraction element a5.

Furthermore, a period T1 of the first contraction maintaining element a4 is preferably 0.1 times or more and 0.2 times or less the natural vibration period Tc generated in the liquid in the pressure chamber 12. In the present embodiment, as shown in table Ta1 in FIG. 5, the period T1 is 1.2 μs, which is 0.14 times the natural vibration period Tc (8.4 μs). When the period T1 of the first contraction maintaining element a4 is too long, the time between the first contraction element a3 and the first re-contraction element a5 will be long, thereby reducing the weight of the droplets discharged from the nozzle 21 and lengthening the period of the first discharge pulse DP1. Moreover, when the period T1 is too short, the effect of reducing the residual vibration cannot be obtained. Therefore, by setting the period T1 to be 0.1 times or more and 0.2 times or less the natural vibration period Tc, it is possible to inhibit a reduction in the weight of the discharged droplets and reduce the residual vibration after the droplets are discharged.

In addition, the total of a period T2 of the first contraction element a3 and a period T3 of the first re-contraction element a5 is preferably less than 0.5 times the natural vibration period Tc. In the present embodiment, as shown in table Ta1 in FIG. 5, the period T2 is 2.1 μs, the period T3 is 1.9 μs, and therefore the total of the period T2 and the period T3 is 4.0 μs. Therefore, the total of the period T2 and the period T3, 4.0 μs, is 0.48 times the natural vibration period Tc (8.4 μs). When the total of the period T2 and the period T3 is increased, it becomes difficult to obtain the effect of reducing the residual vibration by contracting the volume of the pressure chamber in two stages to discharge droplets. Therefore, by setting the total of the period T2 and the period T3 to be less than 0.5 times the natural vibration period Tc, it is possible to reduce the residual vibration after droplet discharge.

When the second discharge pulse DP2 is supplied to the active portion 310, the residual vibration generated by the discharge of droplets by the first discharge pulse DP1 is reduced. Therefore, it is possible to inhibit the residual vibration due to the first discharge pulse DP1 from adversely affecting the discharge of the second discharge pulse DP2. Therefore, even if the interval between the first discharge pulse DP1 and the second discharge pulse DP2 is shortened, when droplets are discharged by the second discharge pulse DP2, the residual vibration due to the first discharge pulse DP1 can be inhibited from causing discharge failures such as droplets not being discharged or variations in the weight of the droplets, and stable discharge can be performed, thereby enabling high-frequency discharge. In particular, when a low-viscosity liquid is used for discharge, the residual vibrations after droplet discharge of the low-viscosity liquid are more intense than those of a high-viscosity liquid. In the present embodiment, the volume of the pressure chamber 12 is contracted in two stages, the first contraction element a3 and the first re-contraction element a5 of the first discharge pulse DP1, to discharge droplets, and thereby residual vibration after droplet discharge can be reduced. Therefore, even if liquid with a relatively low viscosity is used, stable droplet discharge can be performed with the second discharge pulse DP2.

In addition, the period T2 of the first contraction element a3 is preferably longer than the period T3 of the first re-contraction element. That is, it is preferable that the period T2 and the period T3 satisfy the relationship: period T2>period T3. In the present embodiment, the period T2 is 2.1 μs and the period T3 is 1.9 μs. By making the period T2 longer than the period T3 in this way, the flight speed of the discharged droplets is made relatively slow, making it easier for the droplets to combine with the droplets discharged by the second discharge pulse DP2 during flight.

In addition, the rate of potential change of the first contraction element a3 is preferably lower than the rate of potential change of the first re-contraction element a5. The rate of potential change is the rate at which the potential changes per unit time. In other words, the slope of the first contraction element a3 is gentler than the slope of the first re-contraction element a5. In this way, by making the rate of potential change of the first contraction element a3 lower than the rate of potential change of the first re-contraction element a5, it is possible to inhibit the vibration of the liquid in the nozzle 21 from becoming unstable, and by making the rate of potential change of the first re-contraction element a5 relatively high, it is possible to inhibit a reduction in the weight of the discharged droplets.

In addition, the second discharge pulse DP2 divides the drive for contracting the pressure chamber 12 by the second contraction maintaining element b4, thereby contracting the volume of the pressure chamber 12 in two stages, the second contraction element b3 and the second re-contraction element b5 to discharge droplets. By thus contracting the volume of the pressure chamber 12 in two stages to discharge droplets, it is possible to inhibit a reduction in the weight of the discharged droplets, and to suppress the residual vibration of the liquid surface in the nozzle 21 after the droplets are discharged relatively quickly compared to the case in which the volume of the pressure chamber 12 is contracted to discharge droplets by changing the potential in one stage from the fourth potential V4 to the sixth potential V6.

In the second discharge pulse DP2, similarly to the first discharge pulse DP1 described above, the flight speed of the droplets when the volume of the pressure chamber 12 is contracted in two stages to discharge the droplets changes depending on the ratio of the potential difference in the first stage contraction drive to the maximum potential difference in the pulse, which is the potential difference during the two-stage contraction drive of the pressure chamber 12. That is, the flight speed of the ink droplets discharged from the nozzle 21 changes depending on the ratio of the third potential difference ΔV3 to the fourth potential difference ΔV4.

Therefore, the third potential difference ΔV3 is equal to or greater than preferably 50% of the fourth potential difference ΔV4. In the present embodiment, as shown in table Ta1 of FIG. 5, the ratio of the third potential difference ΔV3 to the fourth potential difference ΔV4, which is the maximum potential difference of the drive signal COM, is 55%, and the ratio of the fourth potential difference ΔV4 is 100%. Therefore, the third potential difference ΔV3 is 55% of the fourth potential difference ΔV4. In this way, by setting the third potential difference ΔV3 to be equal to or greater than 50% of the fourth potential difference ΔV4, the flight speed of the droplets discharged by the second discharge pulse DP2 is made relatively fast, and the droplets discharged by the second discharge pulse DP2 and the droplets discharged by the first discharge pulse DP1 can be easily combined during flight before landing on the medium S.

In addition, the third potential difference ΔV3 is preferably equal to or greater than the first potential difference ΔV1. In the present embodiment, as shown in table Ta1 of FIG. 5, the ratio of the third potential difference ΔV3 to the fourth potential difference ΔV4, which is the maximum potential difference of the drive signal COM, is 55%, and the ratio of the first potential difference ΔV1 is 30%. In this way, by setting the third potential difference ΔV3 to be equal to or greater than the first potential difference ΔV1, the flight speed of the droplets discharged by the second discharge pulse DP2 can be set to be equal to or higher than the flight speed of the droplets discharged by the first discharge pulse DP1, and the droplets discharged by the first discharge pulse DP1 and the droplets discharged by the second discharge pulse DP2 can be easily combined during flight before landing on the medium S.

In addition, the fourth potential difference ΔV4 is preferably larger than the second potential difference ΔV2. In other words, it is preferable that the fourth potential difference ΔV4 and the second potential difference ΔV2 satisfy ΔV4>ΔV2. In the present embodiment, the ratio of the fourth potential difference ΔV4 to the fourth potential difference ΔV4 which is the maximum potential difference of the drive signal COM is 100%, and the ratio of the second potential difference ΔV2 is 75%. In this way, by setting the fourth potential difference ΔV4 to be greater than the second potential difference ΔV2, the flight speed of the droplets discharged by the second discharge pulse DP2 is made faster than the flight speed of the droplets discharged by the first discharge pulse DP1, and the two droplets can be easily combined during flight.

Furthermore, when the second discharge pulse DP2 discharges droplets by contracting the volume of the pressure chamber 12 in two stages, the second contraction element b3 and the second re-contraction element b5, as in the present embodiment, a period T4 of the second contraction maintaining element b4 is preferably 0.1 times or more and 0.2 times or less the natural vibration period Tc, similarly to the period T1 of the first contraction maintaining element a4. In the present embodiment, as shown in table Ta1 in FIG. 5, the period T4 is 1.0 μs, which is 0.12 times the natural vibration period Tc (8.4 μs). In this way, by setting the period T4 to be 0.1 times or more and 0.2 times or less the natural vibration period Tc, it is possible to inhibit a reduction in the weight of the discharged droplets and reduce the residual vibration after the droplets are discharged.

Furthermore, the total of a period T5 of the second contraction element b3 and a period T6 of the second re-contraction element b5 is preferably less than 0.5 times the natural vibration period Tc, similarly to the total of the period T2 of the first contraction element a3 and the period T3 of the first re-contraction element a5 described above. In the present embodiment, as shown in table Ta1 in FIG. 5, the period T5 is 2.0 μs, the period T6 is 2.0 μs, and the total is 4.0 μs. The total of the period T5 and the period T6, 4.0 μs, is 0.48 times the natural vibration period Tc (8.4 μs). In this way, by setting the total of the period T5 and the period T6 to be less than 0.5 times the natural vibration period Tc, it is possible to reduce the residual vibration after droplet discharge.

In this way, similarly to the first discharge pulse DP1, the second discharge pulse DP2 of the present embodiment discharges droplets by contracting the volume of the pressure chamber 12 in two stages, the second contraction element b3 and the second re-contraction element b5, thereby the residual vibration of the meniscus of the liquid in the nozzle 21 after the droplet is discharged can be reduced, and therefore the time until the residual vibration subsides can be shortened. Therefore, the period from the end of the second discharge pulse DP2 to the supply of the first discharge pulse DP1 of the next unit period T, that is, one unit period T, can be made relatively short, and high frequency discharge can be achieved.

In addition, the drive signal COM includes a start element z1 that maintains the reference potential Vc for a certain period of time from the start of one unit period T to the beginning of the first discharge pulse DP1, and an end element z2 that maintains the reference potential Vc for a certain period of time from the termination of the second discharge pulse DP2 to the end of one unit period T.

The reference potential Vc is a potential between the first potential V1 and the third potential V3. In this way, by setting the reference potential Vc to a potential between the first potential V1 and the third potential V3, the first contraction element a3 and the first re-contraction element a5 of the first discharge pulse DP1 can contract the pressure chamber 12 using the potential difference from the first potential V1 to the third potential V3 beyond the reference potential Vc, and the weight of the discharged droplets can be ensured.

Further, the reference potential Vc is a potential between the fourth potential V4 and the sixth potential V6. In this manner, the second contraction element b3 and the second re-contraction element b5 of the second discharge pulse DP2 can contract the pressure chamber 12 using the potential difference from the fourth potential V4 to the sixth potential V6 beyond the reference potential Vc, and the weight of the discharged droplets can be ensured. Furthermore, the reference potential Vc is a potential between the fourth potential V4 and the fifth potential V5. This allows the second contraction element b3 of the second discharge pulse DP2 to perform the first stage contraction of the pressure chamber 12 using the potential difference from the fourth potential V4 to the fifth potential V5 beyond the reference potential Vc, and the flight speed of the droplets can be increased and the weight of the droplets can be ensured.

The drive signal COM also includes an intermediate element z3 that maintains the reference potential Vc for a certain period between the first discharge pulse DP1 and the second discharge pulse DP2 of one unit period T.

An interval Td1 between the first discharge pulse DP1 and the second discharge pulse DP2 is preferably two times or more and three times or less the natural vibration period Tc. The interval Td1 between the first discharge pulse DP1 and the second discharge pulse DP2 is the interval between the starting point of the first discharge pulse DP1 and the starting point of the second discharge pulse DP2, and is the total of the period including all elements a1 to a7 of the first discharge pulse DP1 and the period of the intermediate element z3. In the present embodiment, for example, the interval Td1 is 21.2 μs, which is 2.52 times the natural vibration period Tc (8.4 μs). For example, when the interval Td1 is smaller than two times the natural vibration period Tc, the residual vibration after the droplets are discharged by the first discharge pulse DP1 affects the second discharge pulse DP2, resulting in discharge failures such as droplets not being discharged by the second discharge pulse DP2 or the weight of the droplets being unstable. Furthermore, for example, when the interval Td1 is greater than three times the natural vibration period Tc, there is a concern that the droplets discharged by the first discharge pulse DP1 and the second discharge pulse DP2 may not be able to combine before landing on the medium S. Therefore, by setting the interval Td1 to be two times or more and three times or less the natural vibration period Tc, the residual vibration when droplets are discharged by the first discharge pulse DP1 is reduced, thereby the residual vibration can be inhibited from adversely affecting the discharge of droplets by the second discharge pulse DP2, and the droplets discharged by the first discharge pulse DP1 and the second discharge pulse DP2 can be easily combined before landing on the medium S.

In the present embodiment, the first discharge pulse DP1 is an example of a “first discharge pulse”, the second discharge pulse DP2 is an example of a “last discharge pulse”, the second contraction element b3 is an example of a “last contraction element”, the second contraction maintaining element b4 is an example of a “last contraction maintaining element”, and the second re-contraction element b5 is an example of a “last re-contraction element”.

### Second Embodiment

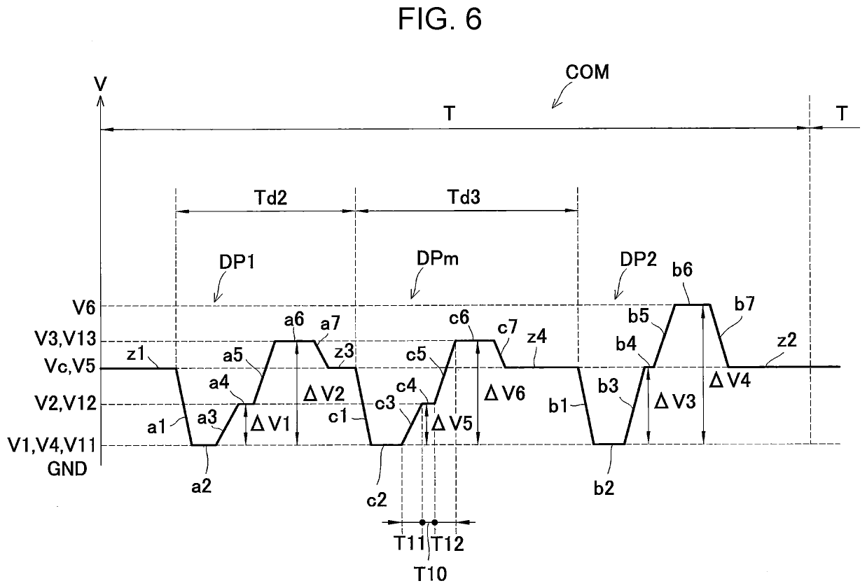

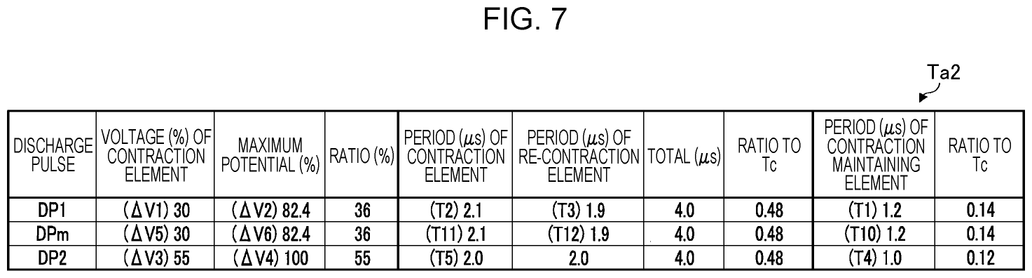

FIG. 6 is a drive waveform showing a drive signal COM according to a second embodiment of the present disclosure. FIG. 7 is a table Ta2 showing specific numerical values of a potential and a period of each element of the drive signal COM. In addition, the same reference numerals are used for the same members as those in the above-described embodiment, and the duplicated descriptions will be omitted.

As shown in FIG. 6, the drive signal COM has, in one unit period T, a first discharge pulse DP1, an intermediate pulse DPm, and a second discharge pulse DP2 in this order in time series. The first discharge pulse DP1, the intermediate pulse DPm, and the second discharge pulse DP2 are each a discharge pulse that discharges droplets. Hereinafter, when there is no need to distinguish between the first discharge pulse DP1, the intermediate pulse DPm, and the second discharge pulse DP2, they will be referred to as discharge pulses. In addition, in two discharge pulses that are continuous in time series, the discharge pulse located earlier in time series is referred to as a preceding discharge pulse, and the discharge pulse located later in time series is referred to as a subsequent discharge pulse. Furthermore, the droplets discharged by each discharge pulse within one unit period T are combined together before landing on the medium S, that is, before landing on the medium S during flight.

The first discharge pulse DP1 and the second discharge pulse DP2 are similar to those in the above-described embodiment, and therefore a duplicated description will be omitted.

In the present embodiment, as shown in table Ta2 of FIG. 7, the ratio of the first potential difference ΔV1 to the fourth potential difference ΔV4, which is the maximum potential difference of the drive signal COM, is 30%, and the ratio of the second potential difference ΔV2 is 82.4%. Therefore, the first potential difference ΔV1 is 36% of the second potential difference ΔV2. Also in the present embodiment, the ratio of the first potential difference ΔV1 is equal to or greater than 20% and less than 50% of the second potential difference ΔV2, which is the maximum potential difference in the first discharge pulse DP1. Therefore, similarly to the first embodiment, the effect of suppressing residual vibrations caused by the discharge of droplets by the first discharge pulse DP1 is achieved.

The intermediate pulse DPm has a third filling element c1, a third filling maintaining element c2, a third contraction element c3, a third contraction maintaining element c4, a third re-contraction element c5, a third re-contraction maintaining element c6, and a third expansion element c7, which are continuous in this order in time series.

The third filling element c1 changes the potential from the reference potential Vc to an eleventh potential V11, thereby expanding the volume of the pressure chamber 12 from the reference volume. By this third filling element c1, the liquid surface of the liquid in the nozzle 21 is drawn toward the pressure chamber 12 side, and liquid is supplied to the pressure chamber 12 from the common liquid chamber 100 side. In the present embodiment, the eleventh potential V11 is the same potential as the first potential V1.

The third filling maintaining element c2 maintains the eleventh potential V11 for a certain period of time. While the third filling maintaining element c2 is being supplied, pressure vibration occurs in the liquid within the pressure chamber 12 with the natural vibration period Tc.

In the intermediate pulse DPm, the drive for contracting the pressure chamber 12 is performed in two stages, the third contraction element c3 and the third re-contraction element c5.

The third contraction element c3 changes the potential from the eleventh potential V11 to a twelfth potential V12, thereby contracting the volume of the pressure chamber 12. The third contraction element c3 causes a liquid column to begin to protrude from the liquid surface of liquid inside the nozzle 21. The potential difference from the eleventh potential V11 to the twelfth potential V12 in the first stage contraction drive of the pressure chamber 12 is a fifth potential difference ΔV5.

The third contraction maintaining element c4 maintains the twelfth potential V12 for a certain period of time. While the third contraction maintaining element c4 is being supplied to the active portion 310, the liquid column continues to extend. In the present embodiment, the twelfth potential V12 is the same potential as the second potential V2.

The third re-contraction element c5 changes the potential from the twelfth potential V12 to a thirteenth potential V13, thereby further contracting the volume of the pressure chamber 12. In the present embodiment, the thirteenth potential V13 is the same potential as the third potential V3. The third re-contraction element c5 causes the liquid column to extend and is then torn off and discharged as droplets. The potential difference from the eleventh potential V11 to the thirteenth potential V13 during the two-stage contraction drive of the pressure chamber is a sixth potential difference ΔV6. The sixth potential difference ΔV6 may also be referred to as the maximum potential difference within the pulse in the intermediate pulse DPm.

In addition, when the intermediate pulse DPm is supplied to the active portion 310, the residual vibration generated by the discharge of droplets by the first discharge pulse DP1 is reduced, and therefore it is possible to inhibit the residual vibration due to the first discharge pulse DP1 from adversely affecting the discharge of the intermediate pulse DPm. In particular, when a low-viscosity liquid is used for discharge, the residual vibrations after droplet discharge of the low-viscosity liquid are more intense than those of a high-viscosity liquid. In the present embodiment, the volume of the pressure chamber 12 is contracted in two stages, the first contraction element a3 and the first re-contraction element a5 of the first discharge pulse DP1, to discharge droplets, and thereby residual vibration after droplet discharge can be reduced. Therefore, even if liquid with a relatively low viscosity is used, stable droplet discharge can be performed with the intermediate pulse DPm.

The third re-contraction maintaining element c6 maintains the thirteenth potential V13 for a certain period of time, and the third expansion element c7 changes the potential from the thirteenth potential V13 to the reference potential Vc. In addition, the third re-contraction maintaining element c6 and the third expansion element c7 have a vibration damping function similarly to the first re-contraction maintaining element a6 and the first expansion element a7.

In this way, similarly to the first discharge pulse DP1, the intermediate pulse DPm of the present embodiment discharges droplets by performing the drive for contracting the pressure chamber 12 to contract the volume of the pressure chamber 12 in two stages, the third contraction element c3 and the third re-contraction element c5, thereby the residual vibration of the meniscus of the liquid in the nozzle 21 after the droplet is discharged can be reduced, and therefore the time until the residual vibration subsides can be reduced. Therefore, even if the interval between the intermediate pulse DPm and the second discharge pulse DP2 is shortened, when droplets are discharged by the second discharge pulse DP2, the residual vibration of the intermediate pulse DPm can be inhibited from causing discharge failures such as droplets not being discharged or variations in the weight of the droplets, and stable discharge can be performed, thereby enabling high-frequency discharge. In particular, when a low-viscosity liquid is used for discharge, the residual vibrations after droplet discharge of the low-viscosity liquid are more intense than those of a high-viscosity liquid. In the present embodiment, the volume of the pressure chamber 12 is contracted in two stages, the third contraction element c3 and the third re-contraction element c5 of the intermediate pulse DPm, to discharge droplets, and thereby residual vibration after droplet discharge can be reduced. Therefore, even if liquid with a relatively low viscosity is used, stable droplet discharge can be performed with the second discharge pulse DP2.

In the intermediate pulse DPm, similarly to the first discharge pulse DP1 of the first embodiment, the flight speed of the droplets when the volume of the pressure chamber 12 is contracted in two stages to discharge the droplets changes depending on the ratio of the potential difference in the first stage contraction drive to the maximum potential difference in the pulse, which is the potential difference during the two-stage contraction drive of the pressure chamber 12. That is, the flight speed of the ink droplets discharged from the nozzle 21 changes depending on the ratio of the fifth potential difference ΔV5 to the sixth potential difference ΔV6.

The twelfth potential V12 of the intermediate pulse DPm is preferably a potential equal to or higher than the second potential V2 and lower than the fifth potential V5. In other words, the fifth potential difference ΔV5 is preferably equal to or greater than the first potential difference ΔV1 and equal to or less than the third potential difference ΔV3. In the present embodiment, the eleventh potential V11 is the same potential as the first potential V1, and the twelfth potential V12 is the same potential as the second potential V2. Therefore, the fifth potential difference ΔV5 is the same potential difference as the first potential difference ΔV1. As shown in table Ta2 of FIG. 7, the ratio of the fifth potential difference ΔV5 to the fourth potential difference ΔV4, which is the maximum potential difference of the drive signal COM, is 30%, and the ratio of the first potential difference ΔV1 is 30%. In this way, by setting the twelfth potential V12 of the intermediate pulse DPm to be equal to or higher than the second potential V2, the flight speed of the droplets discharged by the intermediate pulse DPm can be set to be equal to or higher than the flight speed of the droplets discharged by the first discharge pulse DP1, so that the two droplets can be easily combined during flight. Furthermore, by setting the twelfth potential V12 to a potential lower than the fifth potential V5, the flight speed of the droplets discharged by the second discharge pulse DP2 can be made faster than the flight speed of the droplets discharged by the intermediate pulse DPm, so that the two droplets can be easily combined during flight.

In addition, in the plurality of discharge pulses, the maximum potential difference of the subsequent discharge pulse is preferably equal to or greater than the maximum potential difference of the preceding discharge pulse. In other words, the maximum potential difference of the intermediate pulse DPm is preferably equal to or greater than the maximum potential difference of the first discharge pulse DP1. That is, the sixth potential difference ΔV6 which is the maximum potential difference of the intermediate pulse DPm is preferably equal to or greater than the second potential difference ΔV2 which is the maximum potential difference of the first discharge pulse DP1. In the present embodiment, the ratio of the sixth potential difference ΔV6 to the fourth potential difference ΔV4 which is the maximum potential difference of the drive signal COM is 82.4%, and the ratio of the second potential difference ΔV2 is 82.4%. In this way, by setting the sixth potential difference ΔV6 to be equal to or greater than the second potential difference ΔV2, the flight speed of the droplets discharged by the intermediate pulse DPm can be set to be equal to or higher than the flight speed of the droplets discharged by the first discharge pulse DP1, and the two droplets can be easily combined during flight.

Similarly, the maximum potential difference of the intermediate pulse DPm is preferably equal to or less than the maximum potential difference of the second discharge pulse DP2. That is, the sixth potential difference ΔV6 of the intermediate pulse DPm is preferably a potential difference equal to or less than the fourth potential difference ΔV4 of the second discharge pulse DP2. In the present embodiment, as shown in table Ta2 of FIG. 7, the ratio of the sixth potential difference ΔV6 to the fourth potential difference ΔV4, which is the maximum potential difference of the drive signal COM, is 82.4%, and the ratio of the fourth potential difference ΔV4 is 100%. In this way, by setting the sixth potential difference ΔV6 to be a potential difference equal to or less than the fourth potential difference ΔV4, the flight speed of the droplets discharged by the intermediate pulse DPm can be set to be equal to or less than the flight speed of the droplets discharged by the second discharge pulse DP2, and the two droplets can be easily combined during flight.

Furthermore, a period T10 of the third contraction maintaining element c4 of the intermediate pulse DPm is preferably 0.1 times or more and 0.2 times or less the natural vibration period Tc, similarly to the period T1 of the first contraction maintaining element a4. In the present embodiment, as shown in table Ta2 in FIG. 7, the period T10 is 1.2 μs, which is 0.14 times the natural vibration period Tc (8.4 μs). In this way, by setting the period T10 to be 0.1 times or more and 0.2 times or less the natural vibration period Tc, it is possible to inhibit a reduction in the weight of the discharged droplets and reduce the residual vibration after the droplets are discharged.

Furthermore, the total of a period T11 of the third contraction element c3 and a period T12 of the third re-contraction element c5 is preferably less than 0.5 times the natural vibration period Tc, similarly to the total of the period T2 of the first contraction element a3 and the period T3 of the first re-contraction element a5 described above. In the present embodiment, as shown in table Ta2 in FIG. 7, the period T11 is 2.1 μs, the period T12 is 1.9 μs, and the total is 4.0 μs. The total of the period T11 and the period T12, 4.0 μs, is 0.48 times the natural vibration period Tc (8.4 μs). In this way, by setting the total of the period T11 and the period T12 to be less than 0.5 times the natural vibration period Tc, the residual vibration after droplet discharge can be reduced and one unit period T can be shortened.

In addition, the rate of potential change of the third contraction element c3 is preferably lower than the rate of potential change of the third re-contraction element c5. In other words, the slope of the third contraction element c3 is gentler than the slope of the third re-contraction element c5. In this way, by making the rate of potential change of the third contraction element c3 lower than the rate of potential change of the third re-contraction element c5, it is possible to inhibit the vibration of the liquid in the nozzle 21 from becoming unstable, and by making the rate of potential change of the third re-contraction element c5 relatively high, it is possible to inhibit a reduction in the weight of the discharged droplets.

Note that the drive signal COM includes a start element z1 and an end element z2, similarly to the first embodiment described above.

In addition, the drive signal COM includes a first intermediate element z3 that maintains the reference potential Vc for a certain period of time between the first discharge pulse DP1 and the intermediate pulse DPm of one unit period T, and a second intermediate element z4 that maintains the reference potential Vc for a certain period of time between the intermediate pulse DPm and the second discharge pulse DP2.

The reference potential Vc is a potential between the eleventh potential V11 and the thirteenth potential V13. In this manner, the third contraction element c3 and the third re-contraction element c5 of the intermediate pulse DPm can contract the pressure chamber 12 using the potential difference from the eleventh potential V11 to the thirteenth potential V13 beyond the reference potential Vc, and the weight of the discharged droplets can be ensured.

Each of an interval Td2 between the first discharge pulse DP1 and the intermediate pulse DPm and an interval Td3 between the intermediate pulse DPm and the second discharge pulse DP2 is preferably two times or more and three times or less the natural vibration period Tc. The interval between each discharge pulse is the interval between the starting point of the preceding discharge pulse and the starting point of the subsequent discharge pulse. In the present embodiment, for example, the interval Td2 is 17.1 μs, which is 2.04 times the natural vibration period Tc (8.4 μs). Moreover, the interval Td3 is 21.1 μs, which is 2.51 times the natural vibration period Tc (8.4 μs). When each of the interval Td2 and the interval Td3 is smaller than two times the natural vibration period Tc, the residual vibration after the droplets are discharged by the preceding discharge pulse affects the subsequent discharge pulse, resulting in discharge failures such as droplets not being discharged by the subsequent discharge pulse or the weight of the droplets being unstable. Furthermore, for example, when the interval Td2 and the interval Td3 are greater than three times the natural vibration period Tc, there is a concern that the droplets discharged by the preceding discharge pulse and the subsequent discharge pulse may not be able to combine before landing on the medium S. Therefore, by setting the interval Td2 and the interval Td3 to be two times or more and three times or less the natural vibration period Tc, the residual vibration when droplets are discharged by the preceding discharge pulse is reduced, thereby the residual vibration can be inhibited from adversely affecting the discharge of droplets by the subsequent discharge pulse, and the droplets discharged by the preceding discharge pulse and the subsequent discharge pulse can be easily combined before landing on the medium S.

In the present embodiment, the first discharge pulse DP1 is an example of a “first discharge pulse”, the second discharge pulse DP2 is an example of a “last discharge pulse”, the second contraction element b3 is an example of a “last contraction element”, the second contraction maintaining element b4 is an example of a “last contraction maintaining element”, and the second re-contraction element b5 is an example of a “last re-contraction element”. In addition, the intermediate pulse DPm is an example of an “intermediate pulse”, the third contraction element c3 is an example of a “contraction element”, the third contraction maintaining element c4 is an example of a “contraction maintaining element”, and the third re-contraction element c5 is an example of a “re-contraction element”. Moreover, the eleventh potential V11 is an example of a “start potential”, the twelfth potential V12 is an example of an “intermediate potential”, and the thirteenth potential V13 is an example of an “end potential”.

### Third Embodiment

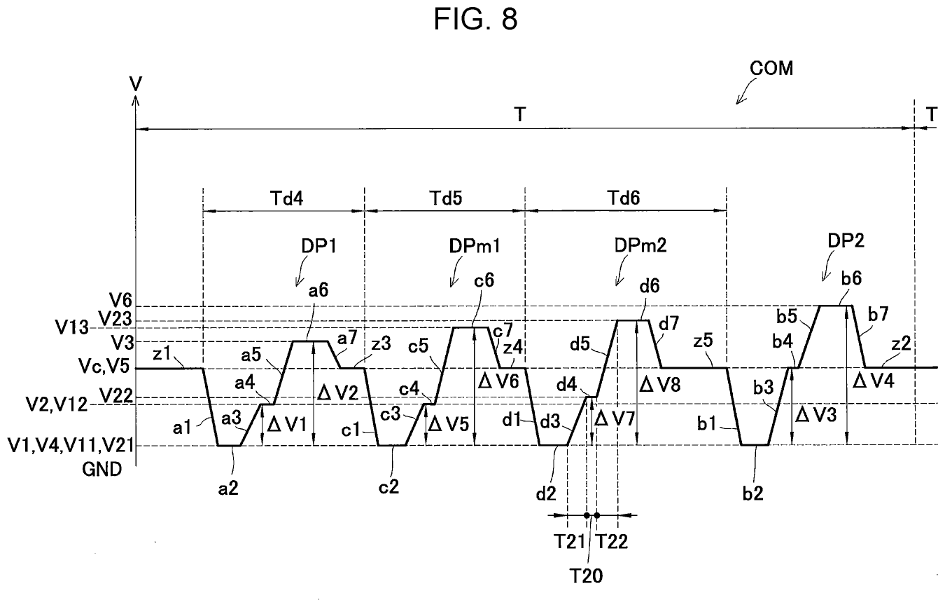

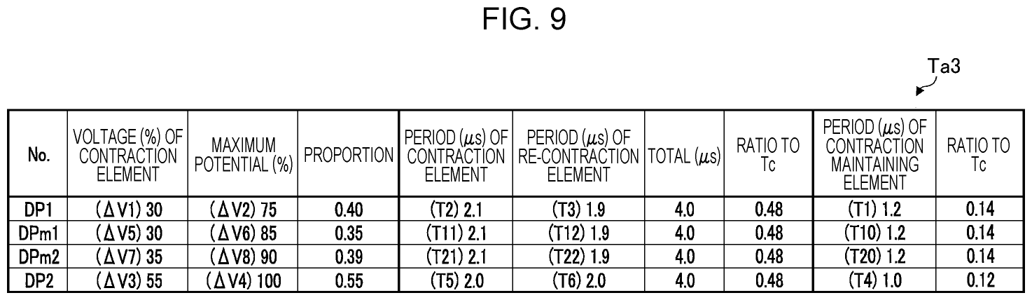

FIG. 8 is a drive waveform showing a drive signal COM according to a third embodiment of the present disclosure. FIG. 9 is a table Ta3 showing specific numerical values of a potential and a period of each element of the drive signal COM. In addition, the same reference numerals are used for the same members as those in the above-described embodiment, and the duplicated descriptions will be omitted.

In the present embodiment, the drive signal COM includes four discharge pulses in one unit period T, and includes two intermediate pulses between the first discharge pulse and the last discharge pulse.

Specifically, as shown in FIG. 8, the drive signal COM has, in one unit period T, a first discharge pulse DP1, a first intermediate pulse DPm1, a second intermediate pulse DPm2, and a second discharge pulse DP2 in this order in time series. The first discharge pulse DP1, the first intermediate pulse DPm1, the second intermediate pulse DPm2, and the second discharge pulse DP2 are each a discharge pulse that discharges droplets. Hereinafter, when there is no need to distinguish among the first discharge pulse DP1, the first intermediate pulse DPm1, the second intermediate pulse DPm2, and the second discharge pulse DP2, they will be referred to as discharge pulses. Moreover, the first intermediate pulse DPm1 and the second intermediate pulse DPm2 are intermediate pulses, and when there is no need to distinguish between the first intermediate pulse DPm1 and the second intermediate pulse DPm2, they will be referred to as intermediate pulses in the following description. In addition, in two discharge pulses that are continuous in time series, the discharge pulse that is earlier in time series is referred to as the preceding discharge pulse, and the discharge pulse that is later in time series is referred to as the subsequent discharge pulse. Furthermore, the droplets discharged from each discharge pulse within one unit period T are combined together before landing on the medium S, that is, before landing on the medium S during flight.

The first discharge pulse DP1 and the second discharge pulse DP2 are similar to those in the first embodiment described above, and therefore a duplicated description will be omitted.

The first intermediate pulse DPm1 is the same as the intermediate pulse DPm of the second embodiment described above, except that the thirteenth potential V13 is different from the intermediate pulse DPm of the second embodiment described above, that is, the sixth potential difference ΔV6 from the eleventh potential V11 to the thirteenth potential V13 is changed, and accordingly the potentials of the third re-contraction maintaining element c6 and the third expansion element c7 are different. In the present embodiment, as shown in table Ta3 of FIG. 9, the ratio of the sixth potential difference ΔV6 to the fourth potential difference ΔV4, which is the maximum potential difference of the drive signal COM, is 85%.

The second intermediate pulse DPm2 has a fourth filling element d1, a fourth filling maintaining element d2, a fourth contraction element d3, a fourth contraction maintaining element d4, a fourth re-contraction element d5, a fourth re-contraction maintaining element d6, and a fourth expansion element d7, which are continuous in this order in time series.

The fourth filling element d1 changes the potential from the reference potential Vc to a twenty-first potential V21, thereby expanding the volume of the pressure chamber 12 from the reference volume. By this fourth filling element d1, the liquid surface of the liquid in the nozzle 21 is drawn toward the pressure chamber 12 side, and liquid is supplied to the pressure chamber 12 from the common liquid chamber 100 side.

The fourth filling maintaining element d2 maintains the twenty-first potential V21 for a certain period of time. While the fourth filling maintaining element d2 is being supplied, pressure vibration occurs in the liquid within the pressure chamber 12 with the natural vibration period Tc.

In the second intermediate pulse DPm2, the drive for contracting the pressure chamber 12 is performed in two stages, the fourth contraction element d3 and the fourth re-contraction element d5.

The fourth contraction element d3 changes the potential from the twenty-first potential V21 to a twenty-second potential V22, thereby contracting the volume of the pressure chamber 12. The fourth contraction element d3 causes a liquid column to begin to protrude from the liquid surface of liquid inside the nozzle 21. The potential difference from the twenty-first potential V21 to the twenty-second potential V22 in the first stage contraction drive of the pressure chamber 12 is a seventh potential difference ΔV7.

The fourth contraction maintaining element d4 maintains the twenty-second potential V22 for a certain period of time. While the fourth contraction maintaining element d4 is being supplied to the active portion 310, the liquid column continues to extend.

The fourth re-contraction element d5 changes the potential from the twenty-second potential V22 to a twenty-third potential V23, thereby further contracting the volume of the pressure chamber 12. The fourth re-contraction element d5 causes the liquid column to extend and is then torn off and discharged as droplets. The potential difference from the twenty-first potential V21 to the twenty-third potential V23 during the two-stage contraction drive of the pressure chamber is an eighth potential difference ΔV8. The eighth potential difference ΔV8 may also be referred to as the maximum potential difference within the pulse in the second intermediate pulse DPm2.

In addition, when the second intermediate pulse DPm2 is supplied to the active portion 310, the residual vibration generated by the discharge of droplets by the first intermediate pulse DPm1 is reduced, and therefore the residual vibration due to the first intermediate pulse DPm1 can be inhibited from adversely affecting the discharge of the second intermediate pulse DPm2, and stable discharge can be performed. In particular, when a low-viscosity liquid is used for discharge, the residual vibrations after droplet discharge of the low-viscosity liquid are more intense than those of a high-viscosity liquid. In the present embodiment, the volume of the pressure chamber 12 is contracted in two stages, the third contraction element c3 and the third re-contraction element c5 of the first intermediate pulse DPm1, to discharge droplets, and thereby residual vibration after droplet discharge can be reduced. Therefore, even if liquid with a relatively low viscosity is used, stable droplet discharge can be performed with the second intermediate pulse DPm2.

The fourth re-contraction maintaining element d6 maintains the twenty-third potential V23, and the fourth expansion element d7 changes the potential from the twenty-third potential V23 to the reference potential Vc. In addition, the fourth re-contraction maintaining element d6 and the fourth expansion element d7 have a vibration damping function similarly to the first re-contraction maintaining element a6 and the first expansion element a7.

In this way, similarly to the first discharge pulse DP1, the second intermediate pulse DPm2 of the present embodiment discharges droplets by performing the drive for contracting the pressure chamber 12 to contract the volume of the pressure chamber 12 in two stages, the fourth contraction element d3 and the fourth re-contraction element d5, thereby the residual vibration of the meniscus of the liquid in the nozzle 21 after the droplet is discharged can be reduced, and therefore the time until the residual vibration subsides can be reduced. Therefore, even if the interval between the second intermediate pulse DPm2 and the second discharge pulse DP2 is shortened, when droplets are discharged by the second discharge pulse DP2, the residual vibration of the second intermediate pulse DPm2 can be inhibited from causing discharge failures such as droplets not being discharged or variations in the weight of the droplets, and stable discharge can be performed, thereby enabling high-frequency discharge. In particular, when a low-viscosity liquid is used for discharge, the residual vibrations after droplet discharge of the low-viscosity liquid are more intense than those of a high-viscosity liquid. In the present embodiment, the volume of the pressure chamber 12 is contracted in two stages, the fourth contraction element d3 and the fourth re-contraction element d5 of the second intermediate pulse DPm2, to discharge droplets, and thereby residual vibration after droplet discharge can be reduced. Therefore, even if liquid with a relatively low viscosity is used, stable droplet discharge can be performed with the second discharge pulse DP2.

In the second intermediate pulse DPm2, similarly to the first discharge pulse DP1 of the first embodiment, the flight speed of the droplets when the volume of the pressure chamber 12 is contracted in two stages to discharge the droplets changes depending on the ratio of the potential difference in the first stage contraction drive to the maximum potential difference in the pulse, which is the potential difference during the two-stage contraction drive of the pressure chamber 12. That is, the flight speed of the ink droplets discharged from the nozzle 21 changes depending on the ratio of the seventh potential difference ΔV7 to the eighth potential difference ΔV8.

In addition, in the plurality of intermediate pulses, the intermediate potential of the subsequent intermediate pulse is preferably a potential equal to or higher than the intermediate potential of the preceding intermediate pulse. In other words, the twenty-second potential V22 (which is the same as the seventh potential difference ΔV7), which is the intermediate potential of the second intermediate pulse DPm2, is preferably a potential equal to or higher than the twelfth potential V12 (which is the same as the fifth potential difference ΔV5), which is the intermediate potential of the first intermediate pulse DPm1, which is located earlier in time series. In the present embodiment, as shown in table Ta3 of FIG. 9, the ratio of the twenty-second potential V22 to the fourth potential difference ΔV4, which is the maximum potential difference of the drive signal COM, is 35%, and the ratio of the twelfth potential V12 is 30%. In this way, by setting the twenty-second potential V22 to a potential equal to or higher than the twelfth potential V12, in the plurality of intermediate pulses, the flight speed of the droplets discharged by the subsequent intermediate pulse can be set to be equal to or higher than the flight speed of the droplets discharged by the preceding intermediate pulse, and the two droplets can be easily combined during flight.

The twenty-second potential V22 of the second intermediate pulse DPm2 is preferably a potential equal to or higher than the second potential V2 and lower than the fifth potential V5. That is, the seventh potential difference ΔV7 is preferably equal to or greater than the first potential difference ΔV1 and equal to or less than the third potential difference ΔV3. As shown in table Ta3 of FIG. 9, the ratio of the seventh potential difference ΔV7 to the fourth potential difference ΔV4, which is the maximum potential difference of the drive signal COM, is 35%, the ratio of the second potential difference ΔV2 is 30%, and the ratio of the third potential difference ΔV3 is 55%. In this way, by setting the twenty-second potential V22 of the second intermediate pulse DPm2 to be equal to or higher than the second potential V2, the flight speed of the droplets discharged by the second intermediate pulse DPm2 can be set to be equal to or higher than the flight speed of the droplets discharged by the first discharge pulse DP1, making it easier to combine with the two droplets during flight. Furthermore, by setting the twenty-second potential V22 to a potential lower than the fifth potential V5, the flight speed of the droplets discharged by the second discharge pulse DP2 can be made faster than the flight speed of the droplets discharged by the first intermediate pulse DPm1, making it easier to combine with the two droplets during flight.

Furthermore, in the plurality of discharge pulses in the drive signal COM, when the termination potential of the first-stage contraction element is set to an intermediate potential, the intermediate potential of the subsequent discharge pulse is preferably a potential equal to or higher than the intermediate potential of the preceding discharge pulse. Specifically, the intermediate potentials in the present embodiment have a relationship of second potential V2 twelfth potential V12 twenty-second potential V22 fifth potential V5 (first potential difference ΔV1 fifth potential difference ΔV5 seventh potential difference ΔV7 fourth potential difference ΔV4). With this configuration, droplets discharged by each discharge pulse can be easily combined during flight.

In addition, the maximum potential difference of the second intermediate pulse DPm2 is preferably equal to or greater than the maximum potential difference of the first discharge pulse DP1. That is, the eighth potential difference ΔV8 is preferably equal to or greater than the second potential difference ΔV2. In other words, it is preferable that the eighth potential difference ΔV8 and the second potential difference ΔV2 satisfy ΔV8≥ΔV2. In the present embodiment, the ratio of the eighth potential difference ΔV8 to the fourth potential difference ΔV4 which is the maximum potential difference of the drive signal COM is 90%, and the ratio of the second potential difference ΔV2 is 75%. In this way, by setting the eighth potential difference ΔV8 to be equal to or greater than the second potential difference ΔV2, the flight speed of the droplets discharged by the second intermediate pulse DPm2 can be set to be equal to or higher than the flight speed of the droplets discharged by the first discharge pulse DP1, and the two droplets can be easily combined during flight.

Furthermore, in the plurality of intermediate pulses, the maximum potential difference of the subsequent intermediate pulse is preferably equal to or greater than the maximum potential difference of the preceding intermediate pulse. In other words, the eighth potential difference ΔV8 of the second intermediate pulse DPm2 is preferably a potential difference equal to or greater than the sixth potential difference ΔV6 of the first intermediate pulse DPm1. In the present embodiment, as shown in table Ta3 of FIG. 9, the ratio of the eighth potential difference ΔV8 to the fourth potential difference ΔV4, which is the maximum potential difference of the drive signal COM, is 90%, and the ratio of the sixth potential difference ΔV6 is 85%. In this way, by setting the maximum potential difference of the second intermediate pulse DPm2 in the subsequent stage to be equal to or greater than the maximum potential difference of the first intermediate pulse DPm1 in the preceding stage, the flight speed of the droplets discharged by the subsequent intermediate pulse can be set to be equal to or higher than the flight speed of the droplets discharged by the preceding intermediate pulse, and the two droplets can be easily combined during flight.

Furthermore, among the plurality of intermediate pulses, the maximum potential difference of the last intermediate pulse in time series is preferably equal to or less than the maximum potential difference of the last discharge pulse. That is, the eighth potential difference ΔV8 of the second intermediate pulse DPm2 is preferably a potential difference equal to or less than the fourth potential difference ΔV4 of the second discharge pulse DP2. In the present embodiment, as shown in table Ta3 of FIG. 9, the ratio of the eighth potential difference ΔV8 to the fourth potential difference ΔV4, which is the maximum potential difference of the drive signal COM, is 90%, and the ratio of the fourth potential difference ΔV4 is 100%. In this way, by setting the eighth potential difference ΔV8 to be a potential difference equal to or less than the fourth potential difference ΔV4, the flight speed of the droplets discharged by the second intermediate pulse DPm2 can be set to be equal to or less than the flight speed of the droplets discharged by the second discharge pulse DP2, and the two droplets can be easily combined during flight.

Furthermore, regarding the relationship of the maximum potential differences, across all of the plurality of discharge pulses, the maximum potential difference of the subsequent discharge pulse is preferably equal to or greater than the maximum potential difference of the preceding discharge pulse. Accordingly, the flight speed of the droplets discharged by the subsequent discharge pulse can be set to be equal to or higher than the flight speed of the droplets discharged by the preceding discharge pulse, and the two droplets can be combined during flight.

Specifically, the relationship is set as follows: second potential difference ΔV2 sixth potential difference ΔV6≤ eighth potential difference ΔV8 fourth potential difference ΔV4.

Furthermore, a period T20 of the fourth contraction maintaining element d4 of the second intermediate pulse DPm2 is preferably 0.1 times or more and 0.2 times or less the natural vibration period Tc, similarly to the period T1 of the first contraction maintaining element a4. In the present embodiment, as shown in table Ta3 in FIG. 9, the period T20 is 1.2 μs, which is 0.14 times the natural vibration period Tc (8.4 μs). In this way, by setting the period T20 to be 0.1 times or more and 0.2 times or less the natural vibration period Tc, it is possible to inhibit a reduction in the weight of the discharged droplets and reduce the residual vibration after the droplets are discharged.

Furthermore, the total of a period T21 of the fourth contraction element d3 and a period T22 of the fourth re-contraction element d5 is preferably less than 0.5 times the natural vibration period Tc, similarly to the total of the period T2 of the first contraction element a3 and the period T3 of the first re-contraction element a5 described above. In the present embodiment, as shown in table Ta3 in FIG. 9, the period T21 is 2.1 μs, the period T22 is 1.9 μs, and the total is 4.0 μs. The total of the period T21 and the period T22, 4.0 μs, is 0.48 times the natural vibration period Tc (8.4 μs). In this way, by setting the total of the period T21 and the period T22 to be less than 0.5 times the natural vibration period Tc, the residual vibration after droplet discharge can be reduced and one unit period T can be shortened.

In addition, the rate of potential change of the fourth contraction element d3 is preferably lower than the rate of potential change of the fourth re-contraction element d5. In other words, the slope of the fourth contraction element d3 is gentler than the slope of the fourth re-contraction element d5. In this way, by making the rate of potential change of the fourth contraction element d3 lower than the rate of potential change of the fourth re-contraction element d5, it is possible to inhibit the vibration of the liquid in the nozzle 21 from becoming unstable, and by making the rate of potential change of the fourth re-contraction element d5 relatively high, it is possible to inhibit a reduction in the weight of the discharged droplets.

Note that the drive signal COM includes a start element z1 and an end element z2, similarly to the first embodiment described above. Furthermore, since the first discharge pulse DP1 and the second discharge pulse DP2 have the same configuration as in the first embodiment, the same effects as those of the first embodiment are achieved. Moreover, the first intermediate pulse DPm1 has the same effect as the intermediate pulse DPm of the second embodiment.

In addition, the drive signal COM includes a first intermediate element z3 that maintains the reference potential Vc for a certain period of time between the first discharge pulse DP1 and the first intermediate pulse DPm1 of one unit period T, a second intermediate element z4 that maintains the reference potential Vc for a certain period of time between the first intermediate pulse DPm1 and the second intermediate pulse DPm2, and a third intermediate element z5 that maintains the reference potential Vc for a certain period of time between the second intermediate pulse DPm2 and the second discharge pulse DP2.

The reference potential Vc is a potential between the twenty-first potential V21 and the twenty-third potential V23. In this manner, it is possible to contract the pressure chamber 12 in two stages by using the potential difference from the twenty-first potential V21 to the twenty-third potential V23 beyond the reference potential Vc, and the weight of the discharged droplets can be ensured. Further, the reference potential Vc is a potential between the twenty-first potential V21 and the twenty-second potential V22. This allows the fourth contraction element d3 to perform the first stage contraction of the pressure chamber 12 using the potential difference from the twenty-first potential V21 to the twenty-second potential V22 beyond the reference potential Vc, and the flight speed of the droplets can be increased and the weight of the droplets can be ensured.

Each of an interval Td4 between the first discharge pulse DP1 and the first intermediate pulse DPm1, an interval Td5 between the first intermediate pulse DPm1 and the second intermediate pulse DPm2, and an interval Td6 between the second intermediate pulse DPm2 and the second discharge pulse DP2 is preferably two times or more and three times or less the natural vibration period Tc. The interval between each discharge pulse is the interval between the starting point of the preceding discharge pulse and the starting point of the subsequent discharge pulse. In the present embodiment, for example, the interval Td4 is 17.1 μs, which is 2.04 times the natural vibration period Tc (8.4 μs). Moreover, the interval Td5 is 17.1 μs, which is 2.04 times the natural vibration period Tc (8.4 μs). Moreover, the interval Td6 is 21.1 μs, which is 2.51 times the natural vibration period Tc (8.4 μs). When each of the intervals Td4 to Td6 is smaller than two times the natural vibration period Tc, the residual vibration after the droplets are discharged by the preceding discharge pulse affects the subsequent discharge pulse, resulting in discharge failures such as droplets not being discharged by the subsequent discharge pulse or the weight of the droplets being unstable. Furthermore, for example, when each of the intervals Td4 to Td6 is greater than three times the natural vibration period Tc, there is a concern that the droplets discharged by the preceding discharge pulse and the subsequent discharge pulse may not be able to combine before landing on the medium S. Therefore, by setting each of the intervals Td4 to Td6 to be two times or more and three times or less the natural vibration period Tc, the residual vibration when droplets are discharged by the preceding discharge pulse is reduced, thereby the residual vibration can be inhibited from adversely affecting the discharge of droplets by the subsequent discharge pulse, and the droplets discharged by the preceding discharge pulse and the subsequent discharge pulse can be easily combined before landing on the medium S.

In the present embodiment, the first discharge pulse DP1 is an example of a “first discharge pulse”, the second discharge pulse DP2 is an example of a “last discharge pulse”, the second contraction element b3 is an example of a “last contraction element”, the second contraction maintaining element b4 is an example of a “last contraction maintaining element”, and the second re-contraction element b5 is an example of a “last re-contraction element”. In addition, the first intermediate pulse DPm1 and the second intermediate pulse DPm2 are examples of “intermediate pulses”, the third contraction element c3 and the fourth contraction element d3 are examples of “contraction elements”, the third contraction maintaining element c4 and the fourth contraction maintaining element d4 are examples of “contraction maintaining elements”, and the third re-contraction element c5 and the fourth re-contraction element d5 are examples of “re-contraction elements”. Moreover, the eleventh potential V11 and the twenty-first potential V21 are examples of “start potentials”, the twelfth potential V12 and the twenty-second potential V22 are examples of “intermediate potentials”, and the thirteenth potential V13 and the twenty-third potential V23 are examples of “end potentials”.

### Fourth Embodiment

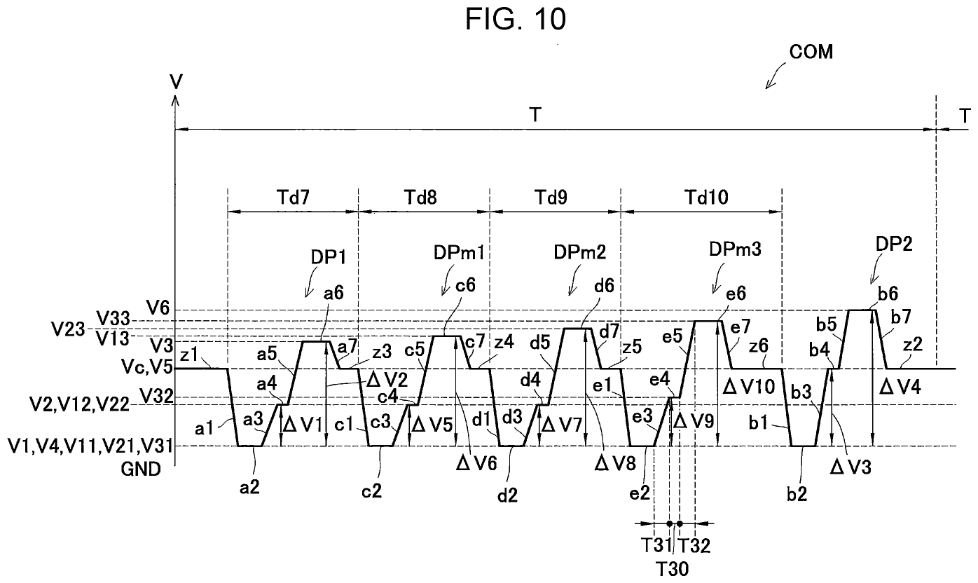

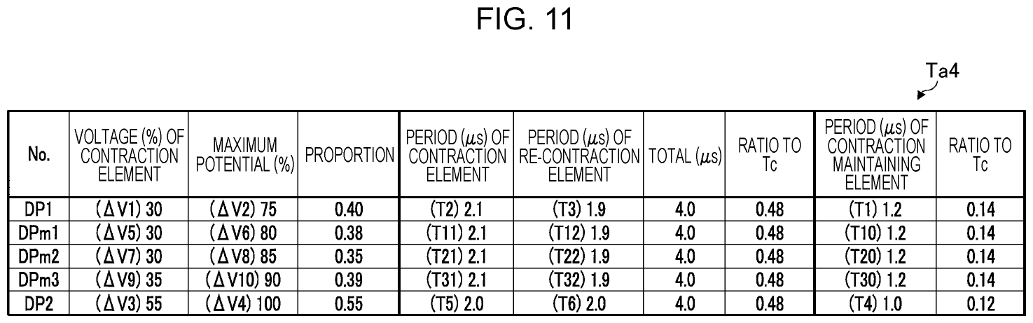

FIG. 10 is a drive waveform showing a drive signal COM according to a fourth embodiment of the present disclosure. FIG. 11 is a table Ta4 showing specific numerical values of a potential and a period of each element of the drive signal COM. In addition, the same reference numerals are used for the same members as those in the above-described embodiment, and the duplicated descriptions will be omitted.

In the present embodiment, the drive signal COM includes five discharge pulses in one unit period T, and includes three intermediate pulses between the first discharge pulse and the last discharge pulse.

Specifically, as shown in FIG. 10, the drive signal COM has, in one unit period T, a first discharge pulse DP1, a first intermediate pulse DPm1, a second intermediate pulse DPm2, a third intermediate pulse DPm3, and a second discharge pulse DP2 in this order in time series. The first discharge pulse DP1, the first intermediate pulse DPm1, the second intermediate pulse DPm2, the third intermediate pulse DPm3, and the second discharge pulse DP2 are each a discharge pulse that discharges droplets. Hereinafter, when there is no need to distinguish among the first discharge pulse DP1, the first intermediate pulse DPm1, the second intermediate pulse DPm2, the third intermediate pulse DPm3, and the second discharge pulse DP2, they will be referred to as discharge pulses. Moreover, the first intermediate pulse DPm1, the second intermediate pulse DPm2, and the third intermediate pulse DPm3 are intermediate pulses, and when there is no need to distinguish between the first intermediate pulse DPm1, the second intermediate pulse DPm2, and the third intermediate pulse DPm3, they will be referred to as intermediate pulses in the following description. In addition, in two discharge pulses that are continuous in time series, the discharge pulse that is earlier in time series is referred to as the preceding discharge pulse, and the discharge pulse that is later in time series is referred to as the subsequent discharge pulse. Furthermore, the droplets discharged from each discharge pulse within one unit period T are combined together before landing on the medium S, that is, before landing on the medium S during flight.

The first discharge pulse DP1 and the second discharge pulse DP2 are similar to those in the third embodiment described above, and therefore a duplicated description will be omitted.

The first intermediate pulse DPm1 of the present embodiment is the same as the first intermediate pulse DPm1 of the third embodiment described above, except that the thirteenth potential V13 for the first intermediate pulse DPm1 of the third embodiment described above, that is, the sixth potential difference ΔV6 from the eleventh potential V11 to the thirteenth potential V13 is changed, and accordingly the potentials of the third re-contraction maintaining element c6 and the third expansion element c7 are different. In the present embodiment, as shown in table Ta4 of FIG. 11, the ratio of the sixth potential difference ΔV6 to the fourth potential difference ΔV4, which is the maximum potential difference of the drive signal COM, is 80%.

The second intermediate pulse DPm2 of the present embodiment is the same as the second intermediate pulse DPm2 of the third embodiment described above, except that the twenty-second potential V22 for the second intermediate pulse DPm2 of the third embodiment described above, that is, the seventh potential difference ΔV7 from the twenty-first potential V21 to the twenty-second potential V22 is changed, and further, the twenty-third potential V23, that is, the eighth potential difference ΔV8 from the twenty-first potential V21 to the twenty-third potential V23 is changed, and accordingly the potentials of the fourth re-contraction maintaining element d6 and the fourth expansion element d7 are different. In the present embodiment, as shown in table Ta4 of FIG. 11, the ratio of the seventh potential difference ΔV7 to the fourth potential difference ΔV4, which is the maximum potential difference of the drive signal COM, is 30%, and the ratio of the eighth potential difference ΔV8 is 85%.

The third intermediate pulse DPm3 has a fifth filling element e1, a fifth filling maintaining element e2, a fifth contraction element e3, a fifth contraction maintaining element e4, a fifth re-contraction element e5, a fifth re-contraction maintaining element e6, and a fifth expansion element e7, which are continuous in this order in time series. These fifth filling element e1 to fifth expansion element e7 are similar to the fourth filling element d1 to fourth expansion element d7 of the second intermediate pulse DPm2 in the third embodiment described above. In addition, a thirty-first potential V31 to a thirty-third potential V33, a ninth potential difference ΔV9, and a tenth potential difference ΔV10 of the third intermediate pulse DPm3 of the present embodiment correspond to the twenty-first potential V21 to the twenty-third potential V23, the seventh potential difference ΔV7, and the eighth potential difference ΔV8 of the second intermediate pulse DPm2 of the third embodiment. In addition, a period T30 of the fifth contraction maintaining element e4, a period T31 of the fifth contraction element e3, and a period T32 of the fifth re-contraction element e5 correspond to the period T20 of the fourth contraction maintaining element d4, the period T21 of the fourth contraction element d3, and the period T22 of the fourth re-contraction element d5 of the second intermediate pulse DPm2 of the third embodiment described above.

Even in this configuration having three intermediate pulses, that is, the first intermediate pulse DPm1, the second intermediate pulse DPm2, and the third intermediate pulse DPm3, between the first discharge pulse DP1 and the second discharge pulse DP2, the same effects as those of the third embodiment described above are achieved.

In addition, in the three intermediate pulses, the intermediate potential of the subsequent intermediate pulse is preferably a potential equal to or higher than the intermediate potential of the preceding intermediate pulse. In other words, the twenty-second potential V22 (same as the seventh potential difference ΔV7), which is the intermediate potential of the second intermediate pulse DPm2, is preferably a potential equal to or higher than the twelfth potential V12 (same as the fifth potential difference ΔV5), which is the intermediate potential of the first intermediate pulse DPm1, which is located earlier in time series. Similarly, the thirty-second potential V32 (same as the ninth potential difference ΔV9), which is the intermediate potential of the third intermediate pulse DPm3, is preferably a potential equal to or higher than the twenty-second potential V22 (same as the seventh potential difference ΔV7), which is the intermediate potential of the second intermediate pulse DPm2. In the present embodiment, as shown in table Ta4 of FIG. 11, the ratio of the twelfth potential V12 to the fourth potential difference ΔV4, which is the maximum potential difference of the drive signal COM, is 30%, the ratio of the twenty-second potential V22 is 30%, and the ratio of the thirty-second potential V32 is 35%. In this way, by making the intermediate potential the same or gradually increasing the intermediate potential in time series, in the plurality of intermediate pulses, the flight speed of the droplets discharged by the subsequent intermediate pulse can be set to be equal to or higher than the flight speed of the droplets discharged by the preceding intermediate pulse, and the two droplets can be easily combined during flight.

Furthermore, in the plurality of discharge pulses in the drive signal COM, when the termination potential of the first-stage contraction element is set to an intermediate potential, the intermediate potential of the subsequent discharge pulse is preferably a potential equal to or higher than the intermediate potential of the preceding discharge pulse. Specifically, the intermediate potentials in the present embodiment have a relationship of second potential V2≤ twelfth potential V12≤ twenty-second potential V22≤ thirty-second potential V32≤ fifth potential V5 (first potential difference ΔV1≤ fifth potential difference ΔV5≤ seventh potential difference ΔV7≤ ninth potential difference ΔV9≤ fourth potential difference ΔV4). With this configuration, droplets discharged by each discharge pulse can be easily combined during flight.

In addition, in the plurality of discharge pulses, the maximum potential difference of the subsequent discharge pulse is preferably equal to or greater than the maximum potential difference of the preceding discharge pulse. Accordingly, the flight speed of the droplets discharged by the subsequent discharge pulse can be set to be equal to or higher than the flight speed of the droplets discharged by the preceding discharge pulse, and the two droplets can be combined during flight. Specifically, the maximum potential differences of the discharge pulses have the relationship: second potential difference ΔV2≤ sixth potential difference ΔV6≤ eighth potential difference ΔV8≤ tenth potential difference ΔV10≤ fourth potential difference ΔV4.

Note that the drive signal COM includes a start element z1 and an end element z2, similarly to the first embodiment described above.

In addition, the first intermediate element z3 to the sixth intermediate element z6, which maintain the reference potential Vc for a certain period of time, are provided between the first discharge pulse DP1 and the first intermediate pulse DPm1, between the first intermediate pulse DPm1 and the second intermediate pulse DPm2, between the second intermediate pulse DPm2 and the third intermediate pulse DPm3, and between the third intermediate pulse DPm3 and the second discharge pulse DP2, respectively.

Each of an interval Td7 between the first discharge pulse DP1 and the first intermediate pulse DPm1, an interval Td8 between the first intermediate pulse DPm1 and the second intermediate pulse DPm2, an interval Td9 between the second intermediate pulse DPm2 and the third intermediate pulse DPm3, and an interval Td10 between the third intermediate pulse DPm3 and the second discharge pulse DP2 is preferably two times or more and three times or less the natural vibration period Tc. The interval between each discharge pulse is the interval between the starting point of the preceding discharge pulse and the starting point of the subsequent discharge pulse. In the present embodiment, for example, each of the interval Td7 to the interval Td9 is 17.1 μs, which is 2.04 times the natural vibration period Tc (8.4 μs). Moreover, the interval Td10 is 21.1 μs, which is 2.51 times the natural vibration period Tc (8.4 μs). By setting each of the intervals Td7 to Td10 to be two times or more and three times or less the natural vibration period Tc, the same effects as those of the aforementioned embodiment can be achieved.

In the present embodiment, the first discharge pulse DP1 is an example of a “first discharge pulse”, the second discharge pulse DP2 is an example of a “last discharge pulse”, the second contraction element b3 is an example of a “last contraction element”, the second contraction maintaining element b4 is an example of a “last contraction maintaining element”, and the second re-contraction element b5 is an example of a “last re-contraction element”.

Furthermore, the first intermediate pulse DPm1, the second intermediate pulse DPm2, and the third intermediate pulse DPm3 are examples of “intermediate pulses”, and the third contraction element c3, the fourth contraction element d3, and the fifth contraction element e3 are examples of “contraction elements”. In addition, the third contraction maintaining element c4, the fourth contraction maintaining element d4, and the fifth contraction maintaining element e4 are examples of “contraction maintaining elements”, and the third re-contraction element c5, the fourth re-contraction element d5, and the fifth re-contraction element e5 are examples of “re-contraction elements”. Moreover, the eleventh potential V11, the twenty-first potential V21, and the thirty-first potential V31 are examples of “start potentials”, the twelfth potential V12, the twenty-second potential V22, and the thirty-second potential V32 are examples of “intermediate potentials”, and the thirteenth potential V13, the twenty-third potential V23, and the thirty-third potential V33 are examples of “end potentials”.

### Fifth Embodiment

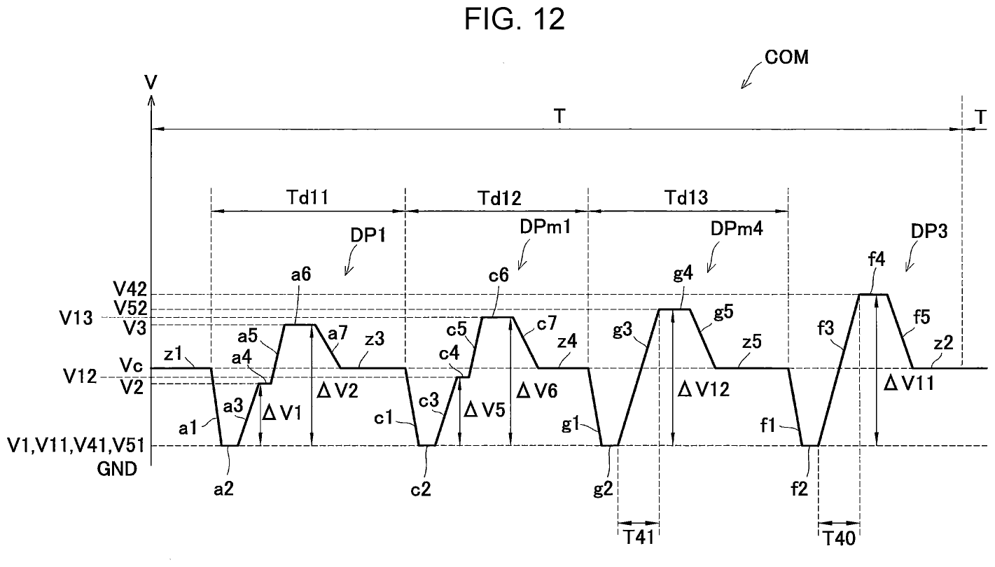

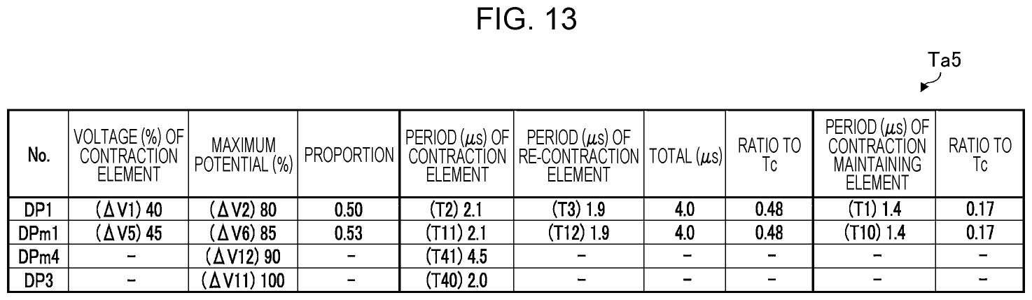

FIG. 12 is a drive waveform showing a drive signal COM according to a fifth embodiment of the present disclosure. FIG. 13 is a table Ta5 showing specific numerical values of a potential and a period of each element of the drive signal COM. In addition, the same reference numerals are used for the same members as those in the above-described embodiment, and the duplicated descriptions will be omitted.

In the present embodiment, the drive signal COM includes four discharge pulses in one unit period T, and includes two intermediate pulses between the first discharge pulse and the last discharge pulse.

Specifically, as shown in FIG. 12, the drive signal COM has, in one unit period T, a first discharge pulse DP1, a first intermediate pulse DPm1, a fourth intermediate pulse DPm4, and a third discharge pulse DP3 in this order in time series. The first discharge pulse DP1, the first intermediate pulse DPm1, the fourth intermediate pulse DPm4, and the third discharge pulse DP3 are each a discharge pulse that discharges droplets. Hereinafter, when there is no need to distinguish among the first discharge pulse DP1, the first intermediate pulse DPm1, the fourth intermediate pulse DPm4, and the third discharge pulse DP3, they will be referred to as discharge pulses. Moreover, the first intermediate pulse DPm1 and the fourth intermediate pulse DPm4 are intermediate pulses, and when there is no need to distinguish between the first intermediate pulse DPm1 and the fourth intermediate pulse DPm4, they will be referred to as intermediate pulses in the following description. In addition, in two discharge pulses that are continuous in time series, the discharge pulse that is earlier in time series is referred to as the preceding discharge pulse, and the discharge pulse that is later in time series is referred to as the subsequent discharge pulse. Furthermore, the droplets discharged from each discharge pulse within one unit period T are combined together before landing on the medium S, that is, before landing on the medium S during flight.

The first discharge pulse DP1 of the present embodiment is different from the first discharge pulse DP1 of the first embodiment described above in that the second potential V2 and the third potential V3 are different, that is, the first potential difference ΔV1 and the second potential difference ΔV2 are different, and further the numerical value of the period T1 of the first contraction maintaining element a4 is different; otherwise, the two are the same. In the present embodiment, as shown in table Ta5 in FIG. 13, the ratio of the second potential V2 (same as the first potential difference ΔV1) to the eleventh potential difference ΔV11, which is the maximum potential difference of the drive signal COM, is 40%, and the ratio of the third potential V3 (same as the second potential difference ΔV2) is 80%. Moreover, the period T1 of the first contraction maintaining element a4 is 1.4 μs.

The third discharge pulse DP3 is generated after the fourth intermediate pulse DPm4 within one unit period T of the drive signal COM. The third discharge pulse DP3 is the last discharge pulse in the present embodiment. The third discharge pulse DP3 has a sixth filling element f1, a sixth filling maintaining element f2, a sixth contraction element f3, a sixth contraction maintaining element f4, and a sixth expansion element f5, which are continuous in this order in time series.

The sixth filling element f1 changes the potential from the reference potential Vc to a forty-first potential V41, thereby expanding the volume of the pressure chamber 12 from the reference volume. By this sixth filling element f1, the liquid surface of the liquid in the nozzle 21 is drawn toward the pressure chamber 12 side, and liquid is supplied to the pressure chamber 12 from the common liquid chamber 100 side.

The sixth filling maintaining element f2 maintains the forty-first potential V41 for a certain period of time. While the sixth filling maintaining element f2 is being supplied, pressure vibration occurs in the liquid within the pressure chamber 12 with the natural vibration period Tc.

The sixth contraction element f3 changes the potential from the forty-first potential V41 to a forty-second potential V42, thereby contracting the volume of the pressure chamber 12. The sixth contraction element f3 causes droplets to be discharged from the nozzle 21. That is, the third discharge pulse DP3 differs from the second discharge pulse DP2, which is the last discharge pulse in the first embodiment, in that the third discharge pulse DP3 contracts the pressure chamber 12 in one stage of the sixth contraction element f3 to discharge a droplet from the nozzle 21. The potential difference from the forty-first potential V41 to the forty-second potential V42 is an eleventh potential difference ΔV11. The eleventh potential difference ΔV11 may also be referred to as the maximum potential difference within the pulse in the third discharge pulse DP3. The eleventh potential difference ΔV11 may also be referred to as the maximum potential difference within the drive signal in the drive signal COM.

The sixth contraction maintaining element f4 maintains the forty-second potential V42 for a certain period of time. While the sixth contraction maintaining element f4 is being supplied to the active portion 310, pressure vibration occurs in the liquid within the pressure chamber 12 with the natural vibration period Tc.

The sixth expansion element f5 changes the potential from the forty-second potential V42 to the reference potential Vc at the timing when the pressure vibration remaining in the ink in the pressure chamber 12 after the sixth contraction element f3 is positive pressure, thereby expanding the volume of the pressure chamber 12. The pressure vibration of the liquid in the pressure chamber is weakened by this sixth expansion element f5.

In other words, the sixth contraction maintaining element f4 and the sixth expansion element f5 have a so-called vibration damping function that weakens the vibration of the liquid surface in the nozzle 21 after the droplets are discharged.

The first intermediate pulse DPm1 of the present embodiment is similar to the first intermediate pulse DPm1 of the third embodiment described above, except that the twelfth potential V12 (same as the fifth potential difference ΔV5) is larger and the period T10 of the third contraction maintaining element c4 is longer than the first intermediate pulse DPm1 of the third embodiment described above.

The fourth intermediate pulse DPm4 is generated after the first intermediate pulse DPm1 within one unit period T of the drive signal COM. The fourth intermediate pulse DPm4, similarly to the third discharge pulse DP3, contracts the volume of the pressure chamber 12 in one stage to discharge a droplet from the nozzle 21. Specifically, the fourth intermediate pulse DPm4 has a seventh filling element g1, a seventh filling maintaining element g2, a seventh contraction element g3, a seventh contraction maintaining element g4, and a seventh expansion element g5, which are continuous in this order in time series.

The seventh filling element g1 changes the potential from the reference potential Vc to a fifty-first potential V51, thereby expanding the volume of the pressure chamber 12 from the reference volume.

The seventh filling maintaining element g2 maintains the fifty-first potential V51 for a certain period of time.

The seventh contraction element g3 changes the potential from the fifty-first potential V51 to a fifty-second potential V52, thereby contracting the volume of the pressure chamber 12. The seventh contraction element g3 causes droplets to be discharged from the nozzle 21. The potential difference from the fifty-first potential V51 to the fifty-second potential V52 is a twelfth potential difference ΔV12. The twelfth potential difference ΔV12 may also be referred to as the maximum potential difference within the pulse in the fourth intermediate pulse DPm4.

The seventh contraction maintaining element g4 maintains the fifty-second potential V52 for a certain period of time.

The seventh expansion element g5 changes the potential from the fifty-second potential V52 to the reference potential Vc at the timing when the pressure vibration remaining in the ink in the pressure chamber 12 after the seventh contraction element g3 is positive pressure, thereby expanding the volume of the pressure chamber 12.

In addition, when droplets are discharged by the fourth intermediate pulse DPm4, the residual vibration generated by the discharge of droplets by the first intermediate pulse DPm1 is reduced, and therefore the residual vibration due to the first intermediate pulse DPm1 can be inhibited from adversely affecting the discharge by the fourth intermediate pulse DPm4. Therefore, when droplets are discharged by the fourth intermediate pulse DPm4, the residual vibration of the first intermediate pulse DPm1 can be inhibited from causing discharge failures such as droplets not being discharged or variations in the weight of the droplets, and stable discharge can be performed, thereby enabling high-frequency discharge. Similarly to the above-described embodiment, the volume of the pressure chamber 12 is contracted in two stages, the third contraction element c3 and the third re-contraction element c5 of the first intermediate pulse DPm1, to discharge droplets, and thereby residual vibration after droplet discharge can be reduced. Therefore, even if liquid with a relatively low viscosity is used, stable droplet discharge can be performed with the fourth intermediate pulse DPm4.

Furthermore, since the first discharge pulse DP1 and the first intermediate pulse DPm1 are discharge pulses that contract the pressure chamber 12 in two stages when discharging droplets, even if the fourth intermediate pulse DPm4 is a discharge pulse that contracts the pressure chamber 12 in one stage when discharging droplets, when the droplets are discharged by the third discharge pulse DP3, discharge failures such as droplets not being discharged due to residual vibration or droplet weight variations can be inhibited, and stable discharge can be performed, thereby enabling high-frequency discharge.

The eleventh potential difference ΔV11 which is the maximum potential difference of the third discharge pulse DP3 is preferably equal to or greater than the second potential difference ΔV2 which is the maximum potential difference of the first discharge pulse DP1. In the present embodiment, as shown in table Ta5 of FIG. 13, the ratio of the eleventh potential difference ΔV11 to the eleventh potential difference ΔV11, which is the maximum potential difference of the drive signal COM, is 100%, and the ratio of the second potential difference ΔV2 is 80%.

In addition, in the plurality of intermediate pulses, the maximum potential difference of the subsequent intermediate pulse is preferably equal to or greater than the maximum potential difference of the preceding intermediate pulse. In other words, the twelfth potential difference ΔV12 which is the maximum potential difference of the fourth intermediate pulse DPm4 is preferably equal to or greater than the sixth potential difference ΔV6 which is the maximum potential difference of the first intermediate pulse DPm1, which is the preceding intermediate pulse. In the present embodiment, as shown in table Ta5 of FIG. 13, the ratio of the twelfth potential difference ΔV12 to the eleventh potential difference ΔV11, which is the maximum potential difference of the drive signal COM, is 90%, and the ratio of the sixth potential difference ΔV6 is 85%. In this way, by setting the maximum potential difference of the subsequent intermediate pulse DPm to be equal to or greater than the maximum potential difference of the preceding intermediate pulse DPm, the flight speed of the droplets discharged by the subsequent intermediate pulse can be set to be equal to or higher than the flight speed of the droplets discharged by the preceding intermediate pulse, and the two droplets can be easily combined during flight.

Furthermore, among the plurality of intermediate pulses, the maximum potential difference of the last intermediate pulse in time series is preferably equal to or less than the maximum potential difference of the last discharge pulse. That is, the twelfth potential difference ΔV12 of the fourth intermediate pulse DPm4 is preferably a potential difference equal to or less than the eleventh potential difference ΔV11 of the third discharge pulse DP3. In the present embodiment, as shown in table Ta5 of FIG. 13, the ratio of the eleventh potential difference ΔV11 to the eleventh potential difference ΔV11, which is the maximum potential difference of the drive signal COM, is 100%, and the ratio of the twelfth potential difference ΔV12 is 90%. In this way, by setting the twelfth potential difference ΔV12 to be a potential difference equal to or less than the eleventh potential difference ΔV11, the flight speed of the droplets discharged by the fourth intermediate pulse DPm4 can be set to be equal to or less than the flight speed of the droplets discharged by the third discharge pulse DP3, and the two droplets can be easily combined during flight.

The eleventh potential difference ΔV11 of the third discharge pulse DP3 is preferably equal to or greater than the first potential difference ΔV1 of the first discharge pulse DP1. In the present embodiment, as shown in table Ta5 of FIG. 13, the ratio of the eleventh potential difference ΔV11 to the eleventh potential difference ΔV11, which is the maximum potential difference of the drive signal COM, is 100%, and the ratio of the first potential difference ΔV1 is 40%.

Furthermore, in the plurality of discharge pulses, the maximum potential difference of the subsequent discharge pulse is preferably equal to or greater than the maximum potential difference of the preceding discharge pulse. Specifically, the maximum potential differences of the discharge pulses have the relationship: second potential difference ΔV2≤ sixth potential difference ΔV6≤ twelfth potential difference ΔV12≤ eleventh potential difference ΔV11. In this way, by setting the maximum potential difference of the subsequent discharge pulse to be equal to or greater than the maximum potential difference of the preceding discharge pulse, the flight speed of the droplets discharged by the subsequent discharge pulse can be made faster than the flight speed of the droplets discharged by the preceding discharge pulse, and the droplets discharged from each discharge pulse within a unit period T can be combined during flight before landing on the medium S.

In addition, similarly to the first embodiment described above, the drive signal COM includes a start element z1 that maintains the reference potential Vc for a certain period of time from the start of one unit period T to the beginning of the first discharge pulse DP1, and an end element z2 that maintains the reference potential Vc for a certain period of time from the termination of the third discharge pulse DP3 to the end of one unit period T.

In addition, the first intermediate element z3 to the fifth intermediate element z5, which maintain the reference potential Vc for a certain period of time, are provided between the first discharge pulse DP1 and the first intermediate pulse DPm1, between the first intermediate pulse DPm1 and the fourth intermediate pulse DPm4, and between the third intermediate pulse DPm3 and the third discharge pulse DP3, respectively.

Each of an interval Td11 between the first discharge pulse DP1 and the first intermediate pulse DPm1, an interval Td12 between the first intermediate pulse DPm1 and the fourth intermediate pulse DPm4, and an interval Td13 between the fourth intermediate pulse DPm4 and the third discharge pulse DP3 is preferably two times or more and three times or less the natural vibration period Tc. The interval between each discharge pulse is the interval between the starting point of the preceding discharge pulse and the starting point of the subsequent discharge pulse. In the present embodiment, for example, the interval Td11 is 22.9 μs, which is 2.73 times the natural vibration period Tc (8.4 μs). The interval Td12 is 21.4 μs, which is 2.55 times the natural vibration period Tc (8.4 μs). The interval Td13 is 23.5 μs, which is 2.80 times the natural vibration period Tc (8.4 μs). By setting each of the intervals Td11 to Td13 to be two times or more and three times or less the natural vibration period Tc, the same effects as those of the aforementioned embodiment can be achieved.

In the present embodiment, the first discharge pulse DP1 is an example of a “first discharge pulse”, the third discharge pulse DP3 is an example of a “last discharge pulse”, and the sixth contraction element f3 is an example of a “last contraction element”. The forty-first potential V41 is an example of the “third potential”, the forty-second potential V42 is an example of the “fourth potential”, and the eleventh potential difference ΔV11 is an example of a “third potential difference ΔV3”.

Moreover, the first intermediate pulse DPm1 is an example of an “intermediate pulse”, and the third contraction element c3 is an example of a “contraction element”. Moreover, the third contraction maintaining element c4 is an example of a “contraction maintaining element”, and the third re-contraction element c5 is an example of a “re-contraction element”. Moreover, the eleventh potential V11 is an example of a “start potential”, the twelfth potential V12 is an example of an “intermediate potential”, and the thirteenth potential V13 is an example of an “end potential”.

### Sixth Embodiment

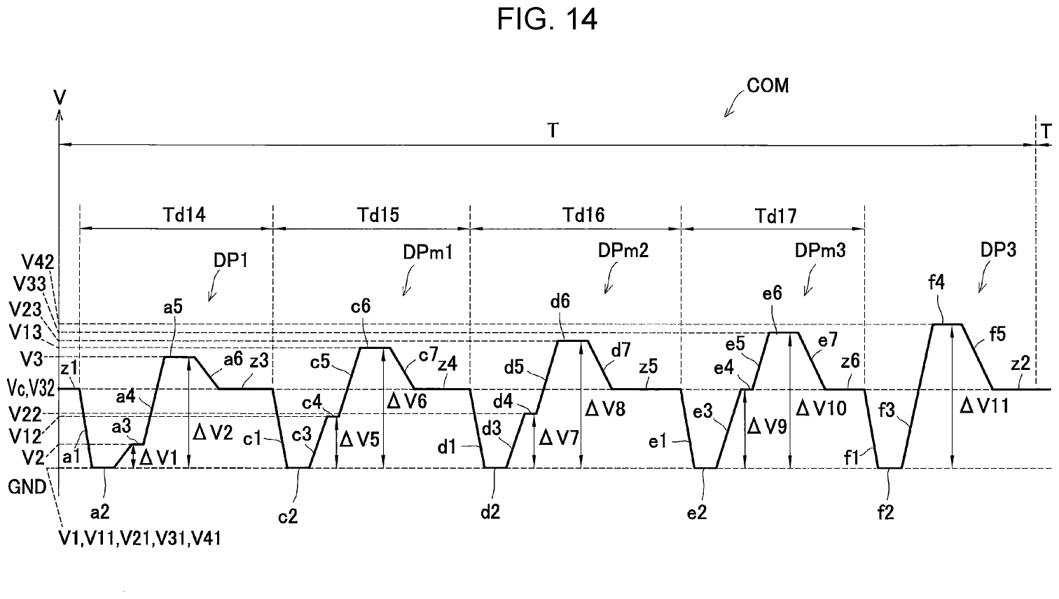

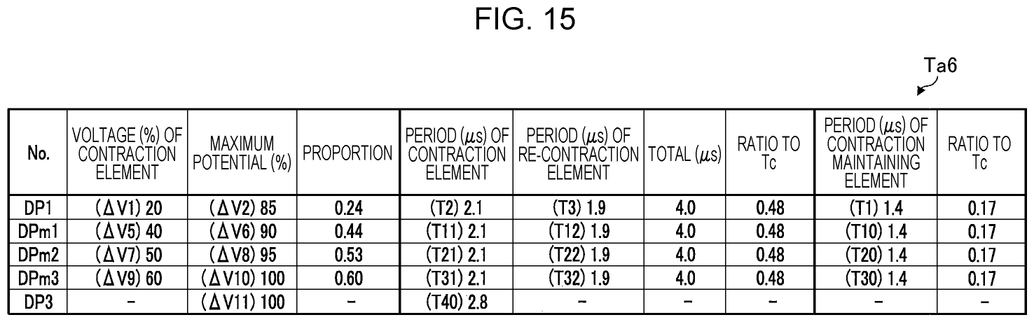

FIG. 14 is a drive waveform showing a drive signal COM according to a sixth embodiment of the present disclosure. FIG. 15 is a table Ta6 showing specific numerical values of a potential and a period of each element of the drive signal COM. In addition, the same reference numerals are used for the same members as those in the above-described embodiment, and the duplicated descriptions will be omitted.

In the present embodiment, the drive signal COM includes five discharge pulses in one unit period T, and includes three intermediate pulses between the first discharge pulse and the last discharge pulse.

Specifically, as shown in FIG. 14, the drive signal COM has, in one unit period T, a first discharge pulse DP1, a first intermediate pulse DPm1, a second intermediate pulse DPm2, a third intermediate pulse DPm3, and a third discharge pulse DP3 in this order in time series. The first discharge pulse DP1, the first intermediate pulse DPm1, the second intermediate pulse DPm2, the third intermediate pulse DPm3, and the third discharge pulse DP3 are each a discharge pulse that discharges droplets. Hereinafter, when there is no need to distinguish among the first discharge pulse DP1, the first intermediate pulse DPm1, the second intermediate pulse DPm2, the third intermediate pulse DPm3, and the third discharge pulse DP3, they will be referred to as discharge pulses. Moreover, the first intermediate pulse DPm1, the second intermediate pulse DPm2, and the third intermediate pulse DPm3 are intermediate pulses, and when there is no need to distinguish between the first intermediate pulse DPm1, the second intermediate pulse DPm2, and the third intermediate pulse DPm3, they will be referred to as intermediate pulses in the following description. In addition, in two discharge pulses that are continuous in time series, the discharge pulse that is earlier in time series is referred to as the preceding discharge pulse, and the discharge pulse that is later in time series is referred to as the subsequent discharge pulse. Furthermore, the droplets discharged from each discharge pulse within one unit period T are combined together before landing on the medium S, that is, before landing on the medium S during flight.

The first discharge pulse DP1 of the present embodiment is similar to that in the fifth embodiment described above, except that the second potential V2 (same as the first potential difference ΔV1) and the third potential V3 (same as the second potential difference ΔV2) of the first discharge pulse DP1 of the fifth embodiment are different potentials. In the present embodiment, as shown in table Ta6 in FIG. 15, the ratio of the second potential V2 (same as the first potential difference ΔV1) of the first discharge pulse DP1 to the eleventh potential difference ΔV11, which is the maximum potential difference of the drive signal COM, is 20%, and the ratio of the third potential V3 (same as the second potential difference ΔV2) is 85%.

The third discharge pulse DP3 of the present embodiment is different from the third discharge pulse DP3 of the fifth embodiment in the period of the sixth contraction element F3; otherwise, the two are similar.

In addition, the first intermediate pulse DPm1 of the present embodiment differs from the first intermediate pulse DPm1 of the fifth embodiment described above in that the twelfth potential V12 (same as the fifth potential difference ΔV5) and the thirteenth potential V13 (same as the sixth potential difference ΔV6) are different; otherwise, the two are similar. In the present embodiment, as shown in table Ta6 in FIG. 15, the ratio of the twelfth potential V12 (same as the fifth potential difference ΔV5) of the first intermediate pulse DPm1 to the eleventh potential difference ΔV11, which is the maximum potential difference of the drive signal COM, is 40%, and the ratio of the thirteenth potential V13 (same as the sixth potential difference ΔV6) is 90%.

The second intermediate pulse DPm2 of the present embodiment differs from the second intermediate pulse DPm2 of the fourth embodiment described above in that the twenty-second potential V22 (equivalent to the seventh potential difference ΔV7) and the twenty-third potential V23 (equivalent to the eighth potential difference ΔV8) are different; otherwise, the two are similar. In the present embodiment, as shown in table Ta6 in FIG. 15, the ratio of the twenty-second potential V22 (same as the seventh potential difference ΔV7) of the second intermediate pulse DPm2 to the eleventh potential difference ΔV11, which is the maximum potential difference of the drive signal COM, is 50%, and the ratio of the twenty-third potential V23 (same as the eighth potential difference ΔV8) is 95%.

The third intermediate pulse DPm3 of the present embodiment differs from the third intermediate pulse DPm3 of the fourth embodiment described above in that the thirty-second potential V32 (same as the ninth potential difference ΔV9), the thirty-third potential V33 (same as the tenth potential difference ΔV10), and the period T30 of the fifth contraction maintaining element are different; otherwise, the two are similar. In the present embodiment, as shown in table Ta6 in FIG. 15, the ratio of the thirty-second potential V32 (same as the ninth potential difference ΔV9) of the third intermediate pulse DPm3 to the eleventh potential difference ΔV11, which is the maximum potential difference of the drive signal COM, is 60%, and the ratio of the thirty-third potential V33 (same as the tenth potential difference ΔV10) is 100%.

In this way, the drive signal COM of the present embodiment differs from the fourth embodiment described above in that the third discharge pulse DP3, which is the last discharge pulse, contracts the pressure chamber 12 in one stage when discharging droplets. However, the first discharge pulse DP1, which is the first discharge pulse, and the first intermediate pulse DPm1, the second intermediate pulse DPm2, and the third intermediate pulse DPm3, which are intermediate pulses, have the same configuration as discharge pulses that contract the pressure chamber 12 in two stages when discharging droplets, and therefore the same effects as those of the fourth embodiment described above are achieved.

Specifically, the relationship of the fifth potential difference ΔV5 the seventh potential difference ΔV7 the ninth potential difference ΔV9 is satisfied, and in the three intermediate pulses, the intermediate potential of the subsequent intermediate pulse is a potential equal to or higher than the intermediate potential of the preceding intermediate pulse. In this way, by making the intermediate potential the same or gradually increasing the intermediate potential in time series, in the plurality of intermediate pulses, the flight speed of the droplets discharged by the subsequent intermediate pulse can be set to be equal to or higher than the flight speed of the droplets discharged by the preceding intermediate pulse, and the two droplets can be easily combined during flight.

Furthermore, it is preferable that the relationship of the sixth potential difference ΔV6 the eighth potential difference ΔV8 the tenth potential difference ΔV10 is satisfied, and in the plurality of intermediate pulses, the maximum potential difference of the subsequent intermediate pulse is equal to or greater than the maximum potential difference of the preceding intermediate pulse. In this way, by setting the maximum potential difference of the subsequent intermediate pulse DPm to be equal to or greater than the maximum potential difference of the preceding intermediate pulse DPm, the flight speed of the droplets discharged by the subsequent intermediate pulse can be set to be equal to or higher than the flight speed of the droplets discharged by the preceding intermediate pulse, and the two droplets can be easily combined during flight.

Furthermore, it is preferable that the relationship of the eighth potential difference ΔV8≤ the eleventh potential difference ΔV11≤ is satisfied, and among the plurality of intermediate pulses, the maximum potential difference of the last intermediate pulse in time series is equal to or less than the maximum potential difference of the last discharge pulse.

In addition, it is preferable that the relationship of the maximum potential differences among the plurality of discharge pulses satisfies the relationship of the second potential difference ΔV2≤ sixth potential difference ΔV6≤ eighth potential difference ΔV8≤ tenth potential difference ΔV10≤ eleventh potential difference ΔV11, and the same conditions are set not only for the intermediate pulses but also for the entire discharge pulses. In other words, in the plurality of discharge pulses, the maximum potential difference of the subsequent discharge pulse is preferably equal to or greater than the maximum potential difference of the preceding discharge pulse. Accordingly, the flight speed of the droplets discharged by the subsequent discharge pulse can be set to be equal to or higher than the flight speed of the droplets discharged by the preceding discharge pulse, and the two droplets can be combined during flight.

Note that the drive signal COM includes a start element z1 and an end element z2, similarly to the fifth embodiment described above.

In addition, the first intermediate element z3 to the sixth intermediate element z6, which maintain the reference potential Vc for a certain period of time, are provided between the first discharge pulse DP1 and the first intermediate pulse DPm1, between the first intermediate pulse DPm1 and the second intermediate pulse DPm2, between the second intermediate pulse DPm2 and the third intermediate pulse DPm3, and between the third intermediate pulse DPm3 and the third discharge pulse DP3, respectively.

Each of an interval Td14 between the first discharge pulse DP1 and the first intermediate pulse DPm1, an interval Td15 between the first intermediate pulse DPm1 and the second intermediate pulse DPm2, an interval Td16 between the second intermediate pulse DPm2 and the third intermediate pulse DPm3, and an interval Td17 between the third intermediate pulse DPm3 and the third discharge pulse DP3 is preferably two times or more and three times or less the natural vibration period Tc. The interval between each discharge pulse is the interval between the starting point of the preceding discharge pulse and the starting point of the subsequent discharge pulse. In the present embodiment, for example, the interval Td14 is 20.7 μs, which is 2.46 times the natural vibration period Tc (8.4 μs). The interval Td15 is 20.2 μs, which is 2.40 times the natural vibration period Tc (8.4 μs). The interval Td16 is 21.7 μs, which is 2.58 times the natural vibration period Tc (8.4 μs). The interval Td17 is 18.7 μs, which is 2.23 times the natural vibration period Tc (8.4 μs). By setting each of the intervals Td14 to Td17 to be two times or more and three times or less the natural vibration period Tc, the same effects as those of the aforementioned embodiment can be achieved.

In the present embodiment, the first discharge pulse DP1 is an example of a “first discharge pulse”, the third discharge pulse DP3 is an example of a “last discharge pulse”, and the sixth contraction element f3 is an example of a “last contraction element”. The forty-first potential V41 is an example of the “third potential”, the forty-second potential V42 is an example of the “fourth potential”, and the eleventh potential difference ΔV11 is an example of a “third potential difference ΔV3”.

Furthermore, the first intermediate pulse DPm1, the second intermediate pulse DPm2, and the third intermediate pulse DPm3 are examples of “intermediate pulses”, and the third contraction element c3, the fourth contraction element d3, and the fifth contraction element e3 are examples of “contraction elements”. In addition, the third contraction maintaining element c4, the fourth contraction maintaining element d4, and the fifth contraction maintaining element e4 are examples of “contraction maintaining elements”, and the third re-contraction element c5, the fourth re-contraction element d5, and the fifth re-contraction element e5 are examples of “re-contraction elements”. Moreover, the eleventh potential V11, the twenty-first potential V21, and the thirty-first potential V31 are examples of “start potentials”, the twelfth potential V12, the twenty-second potential V22, and the thirty-second potential V32 are examples of “intermediate potentials”, and the thirteenth potential V13, the twenty-third potential V23, and the thirty-third potential V33 are examples of “end potentials”.

### OTHER EMBODIMENTS

Although each embodiment of the present disclosure was described above, the basic configuration of the present disclosure is not limited to the above embodiments.

In each of the above-described embodiments, a thin-film type piezoelectric actuator 300 was used as the drive element for generating a pressure change in the pressure chamber 12, but the present disclosure is not particularly limited thereto, and as the drive element, for example, a thick-film type piezoelectric actuator formed by a method such as adhering a green sheet, a longitudinal vibration type piezoelectric actuator in which piezoelectric material and electrode forming material are alternately stacked to expand and contract in the axial direction, or the like can be used. Moreover, as the drive element, a so-called electrostatic actuator that deforms a vibration plate by an electrostatic force to eject droplets from the nozzle 21 or the like can be used.

Further, the present disclosure is intended to cover a wide range of liquid ejecting apparatuses equipped with liquid ejecting heads. Examples of the liquid ejecting head include recording heads such as various ink jet recording heads used in an image recording apparatus such as a printer, and coloring material ejecting heads used in the manufacture of color filters in liquid crystal displays and the like. Examples of the liquid ejecting head include an electrode material ejecting head used for forming an electrode in an organic EL display, a field emission display (FED), and the like, and a bioorganic substance ejecting head used for manufacturing a biochip. The present disclosure can also be applied to liquid ejecting apparatuses equipped with these liquid ejecting heads.

### Supplementary Notes

From the above-mentioned exemplary embodiments, the following configurations can be understood, for example.

According to Aspect 1 which is a preferred aspect, there is provided a liquid ejecting apparatus including: a discharge portion having a nozzle that ejects liquid, a pressure chamber that communicates with the nozzle, and a drive element that causes a pressure fluctuation in the liquid in the pressure chamber when a drive signal is supplied to the drive element; and a drive signal generation section that generates the drive signal, in which the drive signal includes a plurality of discharge pulses corresponding to a plurality of droplets that combine before landing on a medium, a first discharge pulse in time series among the plurality of discharge pulses includes a first contraction element that changes a potential from a first potential to a second potential to contract a volume of the pressure chamber, a first contraction maintaining element that maintains the second potential following the first contraction element, and a first re-contraction element that changes a potential from the second potential to a third potential following the first contraction maintaining element to further contract the volume of the pressure chamber, a last discharge pulse in time series among the plurality of discharge pulses includes a last contraction element that changes a potential from a fourth potential to a fifth potential to contract the volume of the pressure chamber, and a first potential difference from the first potential to the second potential of the first discharge pulse is equal to or greater than 20% and less than 50% of a second potential difference from the first potential to the third potential. In this way, by contracting the pressure chamber in two stages, the first contraction element and the first re-contraction element of the first discharge pulse, to discharge droplets, it is possible to inhibit residual vibrations after droplet discharge. Therefore, even if the interval between the discharge pulses is narrowed, discharge failure of the droplets of the last discharge pulse due to residual vibration can be inhibited, thereby enabling stable discharge, and it is possible to inhibit a reduction in the weight of the discharged droplets. In addition, by setting the first potential difference of the first discharge pulse to be greater than or equal to 20% and less than 50% of the second potential difference, the flight speed of the droplets discharged by the first discharge pulse is made relatively slow, and the droplets can be easily combined with the droplets discharged by the last discharge pulse during flight.

In Aspect 2 which is a specific example of Aspect 1, a third potential difference from the fourth potential to the fifth potential of the last discharge pulse is equal to or greater than the first potential difference. According to this, the flight speed of the droplets discharged by the last discharge pulse can be set to be equal to or higher than the flight speed of the droplets discharged by the first discharge pulse, and the two droplets can be easily combined during flight.

In Aspect 3 which is a specific example of Aspect 1, the drive signal includes a start element that maintains a reference potential from a start of one drive period to a beginning of the first discharge pulse, and an end element that maintains the reference potential from the last discharge pulse to an end of the one drive period, and the reference potential is a potential between the first potential and the third potential. According to this, it is possible to contract the pressure chamber by using the potential difference from the first potential to the third potential beyond the reference potential, and the weight of the discharged droplets can be ensured.

In Aspect 4 which is a specific example of Aspect 1, a pulse interval between the plurality of discharge pulses is two times or more and three times or less a natural vibration period generated in the liquid in the pressure chamber. According to this, by setting the interval Td1 to be two times or more and three times or less the natural vibration period, the residual vibration when droplets are discharged by the first discharge pulse is reduced, thereby the residual vibration can be inhibited from adversely affecting the discharge of droplets by the last discharge pulse, and the droplets discharged by the two discharge pulses can be easily combined before landing on the medium.

In Aspect 5 which is a specific example of Aspect 1, in the first discharge pulse, a rate of potential change of the first contraction element is lower than a rate of potential change of the first re-contraction element. According to this, by making the rate of potential change of the first contraction element lower than the rate of potential change of the first re-contraction element, it is possible to inhibit the vibration of the liquid in the nozzle from becoming unstable, and by making the rate of potential change of the first re-contraction element relatively high, it is possible to inhibit a reduction in the weight of the discharged droplets.

In Aspect 6 which is a specific example of Aspect 1, a period of the first contraction maintaining element is 0.1 times or more and 0.2 times or less a natural vibration period generated in the liquid in the pressure chamber. In this way, by setting the period of the first contraction maintaining element to be 0.1 times or more and 0.2 times or less the natural vibration period, it is possible to inhibit a reduction in the weight of the discharged droplets and reduce the residual vibration after the droplets are discharged.

In Aspect 7 which is a specific example of Aspect 1, a total of a period of the first contraction element and a period of the first re-contraction element is less than 0.5 times a natural vibration period generated in the liquid in the pressure chamber. In this way, by setting the total of the period of the first contraction element and the period of the first re-contraction element to be less than 0.5 times the natural vibration period, it is possible to reduce the residual vibration after droplet discharge.

In Aspect 8 which is a specific example of Aspect 1, the last discharge pulse includes a last contraction maintaining element that maintains the fifth potential following the last contraction element, and a last re-contraction element that changes a potential from the fifth potential to a sixth potential following the last contraction maintaining element to further contract the volume of the pressure chamber, a fourth potential difference from the fourth potential to the sixth potential is greater than the second potential difference, and a third potential difference from the fourth potential to the fifth potential is equal to or greater than 50% of the fourth potential difference. In this way, by setting the third potential difference to be equal to or greater than 50% of the fourth potential difference, the flight speed of the droplets discharged by the last discharge pulse is made relatively fast, and the droplets discharged by the last discharge pulse and the droplets discharged by the first discharge pulse can be easily combined during flight before landing on the medium.

In Aspect 9 which is a specific example of Aspect 1, the drive signal includes at least one intermediate pulse, which is the discharge pulse, between the first discharge pulse and the last discharge pulse, the intermediate pulse includes a contraction element that changes a potential from a start potential to an intermediate potential to contract the volume of the pressure chamber, a contraction maintaining element that maintains the intermediate potential following the contraction element, and a re-contraction element that changes a potential from the intermediate potential to an end potential following the contraction maintaining element, and the intermediate potential of the intermediate pulse is a potential equal to or higher than the second potential and less than the fifth potential. In this way, by setting the intermediate potential of the intermediate pulse to be equal to or higher than the second potential, the flight speed of the droplets discharged by the intermediate pulse can be set to be equal to or higher than the flight speed of the droplets discharged by the first discharge pulse, so that the two droplets can be easily combined during flight. Furthermore, by setting the intermediate potential to a potential lower than the fifth potential, the flight speed of the droplets discharged by the last discharge pulse can be made faster than the flight speed of the droplets discharged by the intermediate pulse, so that the two droplets can be easily combined during flight.

In Aspect 10 which is a specific example of Aspect 9, in a plurality of the intermediate pulses, the intermediate potential of the intermediate pulse located later in time series is equal to or higher than the intermediate potential of the intermediate pulse located earlier in time series. According to this, the flight speed of the droplets discharged by the subsequent intermediate pulse can be set to be equal to or higher than the flight speed of the droplets discharged by the preceding intermediate pulse, and the two droplets can be easily combined during flight.

In Aspect 11 which is a specific example of Aspect 1, a third potential difference from the fourth potential to the fifth potential of the last discharge pulse is equal to or greater than the second potential difference. According to this, by setting the third potential difference to be equal to or greater than the second potential difference, the flight speed of the droplets discharged by the last discharge pulse can be set to be equal to or higher than the flight speed of the droplets discharged by the first discharge pulse, and the two droplets can be easily combined during flight.

According to Aspect 12 which is a preferred aspect, there is provided a method for driving a liquid ejecting apparatus including a discharge portion having a drive element that causes a pressure fluctuation in liquid in a pressure chamber that communicates with a nozzle that ejects the liquid when a drive signal is supplied to the drive element, in which the drive signal includes a plurality of discharge pulses corresponding to a plurality of droplets that combine before landing on a medium, a first discharge pulse in time series among the plurality of discharge pulses includes a first contraction element that changes a potential from a first potential to a second potential to contract a volume of the pressure chamber, a first contraction maintaining element that maintains the second potential following the first contraction element, and a first re-contraction element that changes a potential from the second potential to a third potential following the first contraction maintaining element to further contract the volume of the pressure chamber, a last discharge pulse in time series among the plurality of discharge pulses includes a last contraction element that changes a potential from a fourth potential to a fifth potential to contract the volume of the pressure chamber, and a first potential difference from the first potential to the second potential of the first discharge pulse is equal to or greater than 20% and less than 50% of a second potential difference from the first potential to the third potential. In this way, by contracting the pressure chamber in two stages, the first contraction element and the first re-contraction element of the first discharge pulse, to discharge droplets, it is possible to inhibit residual vibrations after droplet discharge. Therefore, even if the interval between the discharge pulses is narrowed, discharge failure of the droplets of the last discharge pulse due to residual vibration can be inhibited, thereby enabling stable discharge, and it is possible to inhibit a reduction in the weight of the discharged droplets. In addition, by setting the first potential difference of the first discharge pulse to be greater than or equal to 20% and less than 50% of the second potential difference, the flight speed of the droplets discharged by the first discharge pulse is made relatively slow, and the droplets can be easily combined with the droplets discharged by the last discharge pulse during flight.

What is claimed is:

1. A liquid ejecting apparatus comprising:
a discharge portion having a nozzle that ejects liquid, a pressure chamber that communicates with the nozzle, and a drive element that is configured to cause a pressure fluctuation in the liquid in the pressure chamber when a drive signal is supplied to the drive element; and
a drive signal generation section that is configured to generate the drive signal, wherein
the drive signal includes a plurality of discharge pulses corresponding to a plurality of droplets that combine before landing on a medium,
a first discharge pulse in time series among the plurality of discharge pulses includes a first contraction element that changes a potential from a first potential to a second potential to contract a volume of the pressure chamber, a first contraction maintaining element that maintains the second potential following the first contraction element, and a first re-contraction element that changes a potential from the second potential to a third potential following the first contraction maintaining element to further contract the volume of the pressure chamber,
a last discharge pulse in time series among the plurality of discharge pulses includes a last contraction element that changes a potential from a fourth potential to a fifth potential to contract the volume of the pressure chamber, and
a first potential difference from the first potential to the second potential of the first discharge pulse is equal to or greater than 20% and less than 50% of a second potential difference from the first potential to the third potential.

2. The liquid ejecting apparatus according to claim 1,
wherein a third potential difference from the fourth potential to the fifth potential of the last discharge pulse is equal to or greater than the first potential difference.

3. The liquid ejecting apparatus according to claim 1, wherein
the drive signal includes a start element that maintains a reference potential from a start of one drive period to a beginning of the first discharge pulse, and an end element that maintains the reference potential from the last discharge pulse to an end of the one drive period, and
the reference potential is a potential between the first potential and the third potential.

4. The liquid ejecting apparatus according to claim 1, wherein
a pulse interval between the plurality of discharge pulses is two times or more and three times or less a natural vibration period generated in the liquid in the pressure chamber.

5. The liquid ejecting apparatus according to claim 1, wherein
in the first discharge pulse, a rate of potential change of the first contraction element is lower than a rate of potential change of the first re-contraction element.

6. The liquid ejecting apparatus according to claim 1, wherein
a period of the first contraction maintaining element is 0.1 times or more and 0.2 times or less a natural vibration period generated in the liquid in the pressure chamber.

7. The liquid ejecting apparatus according to claim 1, wherein
a total of a period of the first contraction element and a period of the first re-contraction element is less than 0.5 times a natural vibration period generated in the liquid in the pressure chamber.

8. The liquid ejecting apparatus according to claim 1, wherein
the last discharge pulse includes a last contraction maintaining element that maintains the fifth potential following the last contraction element, and a last re-contraction element that changes a potential from the fifth potential to a sixth potential following the last contraction maintaining element to further contract the volume of the pressure chamber,
a fourth potential difference from the fourth potential to the sixth potential is greater than the second potential difference, and
a third potential difference from the fourth potential to the fifth potential is equal to or greater than 50% of the fourth potential difference.

9. The liquid ejecting apparatus according to claim 1, wherein
the drive signal includes at least one intermediate pulse, which is the discharge pulse, between the first discharge pulse and the last discharge pulse,
the intermediate pulse includes a contraction element that changes a potential from a start potential to an intermediate potential to contract the volume of the pressure chamber, a contraction maintaining element that maintains the intermediate potential following the contraction element, and a re-contraction element that changes a potential from the intermediate potential to an end potential following the contraction maintaining element, and
the intermediate potential of the intermediate pulse is a potential equal to or higher than the second potential and less than the fifth potential.

10. The liquid ejecting apparatus according to claim 9, wherein
in a plurality of the intermediate pulses, the intermediate potential of the intermediate pulse located later in time series is equal to or higher than the intermediate potential of the intermediate pulse located earlier in time series.

11. The liquid ejecting apparatus according to claim 1, wherein
a third potential difference from the fourth potential to the fifth potential of the last discharge pulse is equal to or greater than the second potential difference.

12. A method for driving a liquid ejecting apparatus including a discharge portion having a drive element that is configured to cause a pressure fluctuation in liquid in a pressure chamber that communicates with a nozzle that ejects the liquid when a drive signal is supplied to the drive element, wherein
the drive signal includes a plurality of discharge pulses corresponding to a plurality of droplets that combine before landing on a medium,
a first discharge pulse in time series among the plurality of discharge pulses includes a first contraction element that changes a potential from a first potential to a second potential to contract a volume of the pressure chamber, a first contraction maintaining element that maintains the second potential following the first contraction element, and a first re-contraction element that changes a potential from the second potential to a third potential following the first contraction maintaining element to further contract the volume of the pressure chamber,
a last discharge pulse in time series among the plurality of discharge pulses includes a last contraction element that changes a potential from a fourth potential to a fifth potential to contract the volume of the pressure chamber, and
a first potential difference from the first potential to the second potential of the first discharge pulse is equal to or greater than 20% and less than 50% of a second potential difference from the first potential to the third potential.
